(19) United States
(12) Patent Application Publication
(10) Pub. No.: US 2020/0402006 A1
(43) Pub. Date: Dec. 24, 2020

(54) SYSTEM AND METHOD FOR MANAGING COMMUNICATIONS OVER AN ORGANIZATIONAL DATA COMMUNICATION NETWORK

(71) Applicant: Gil MARGALIT, Herzliya (IL)

(72) Inventor: Gil MARGALIT, Herzliya (IL)

(21) Appl. No.: 16/970,980

(22) PCT Filed: Feb. 21, 2019
(86) PCT No.: PCT/IL2019/050204

§ 371 Date: Aug. 19, 2020

Related U.S. Application Data
(60) Provisional application No. 62/633,617, filed on Feb. 22, 2018.

(51) Int. Cl. G06Q 10/10; H04W 4/12; H04M 1/725; H04M 7/00

(52) U.S. Cl. CPC G06Q 10/103; H04M 7/006; H04M 1/72547; H04W 4/12

(57) ABSTRACT

A system and a method of managing communication of at least one user of a respective first computing device over an organizational communication network (OCN). The method comprises: receiving an indication of a triggering event related to the user, wherein the indication comprises at least one trigger property; generating a thread, comprising at least one thread data element based on the at least one trigger property; attributing a membership property to the user; presenting the at least one thread data element on a context-based user interface (CBUI) of the at least one first computing device according to at least one of the membership property and the trigger property; and enabling the at least one user to perform at least one action over the OCN, in the context of the thread representation on the CBUI, based on the at least one thread data element and the membership property.

### FIELD OF THE INVENTION

The present invention relates generally to the field of communication networks. More specifically, the present invention relates to managing organizational communication networks.

### BACKGROUND OF THE INVENTION

State of the art communication among members of organizations is typically non-standardized, non-centralized, and cannot be monitored or handled from a single access point.

### SUMMARY OF THE INVENTION

A system and a method that would enable organizations to concentrate all organization-related communication among its members into one controllable, followable, auditable network is desired.

Furthermore, it is in the interest of organization members to have their organization-related communication accessed, presented, sorted and centralized in a unified, context based user interface (CBUI). The CBUI may be identity driven (e.g., personalized) and event driven (e.g., context based) and may allow organization members efficient and quick access to other entities in the organization, and data stored thereon, according to their specific roles in the organization and according to specific communication properties, as explained herein.

Embodiments of the present invention may include a system for managing communication between users of computing devices over an organizational communication network (OCN).

Embodiments of the system may include a non-transitory memory device upon which computer-readable instruction code modules are stored. Embodiments may further include, a processor, associated with the non-transitory memory device, and configured to execute the instruction code modules, a database, wherein user data relating to at least one user is stored; and at least one communication module, associated with the processor and configured to transfer communication among computing devices within the OCN, according to the stored user data and according to a set of predefined rules.

According to some embodiments, the embodiments may include at least one communication module for connecting the OCN with an external communication network (ECN).

The processor may be configured to perform protocol conversion of communication between a first communication protocol of the OCN and a second protocol of at least one ECN, according to the stored user data and upon execution of the instruction code modules.

At least one communication module may include at least one switch, and the processor may be configured to instruct the switch to direct communication within the OCN between at least two computing devices, according to the stored user data and according to the set of predefined rules.

The terms “switch” and “router” may refer herein to communication modules and may be used interchangeably.

At least one communication module may include at least one router, and the processor may be configured to instruct the router to direct communication within the OCN between at least two computing devices, according to the stored user data and according to the set of predefined rules.

The processor may be configured to instruct the at least one router to route communication between the OCN and at least one ECN, according to the stored user data and according to the set of predefined rules.

According to some embodiments, at least one communication module may include at least one gateway server, and ruting of communication between the OCN and at least one ECN may be performed via the at least one gateway server.

According to some embodiments, at least one ECN may be selected from a group including one or more of: a Wide Area Network (WAN), a Metropolitan Area Network (MAN), an Enterprise Private Network (EPN), a Virtual Private Network (VPN), a Local Area Network (LAN), a cellular network, a Public Switched Telephone Network (PSTN), a satellite communication network, an Internet of Things (IoT) network, a machine to machine (M2M) network and third-party application proprietary networks.

According to some embodiments, at least one ECN communication protocol may be selected from a group including one or more of: Open Systems Interconnection (OSI) protocols (e.g., TCP/IP protocols), Voice over Internet Protocol (VoIP), Public Switched Telephone Network (PSTN) protocol, email messaging protocols, cellular communication protocols and cellular text messaging protocols, and third-part application proprietary protocols (e.g., WhatsApp).

The stored user data may include data relating to at least one of: a first user's identity, the first user's role in the organization, and access-permissions attributed to the first user.

The stored user data may include data relating to a first communication with the first user over the OCN. For example, the user data may include at least one of the first communication's subject, the first communication's content, the first communication's context, and at least one identity of a second user related to the first communication.

The stored user data may include data relating to at least one second communication of an ECN, wherein the second communication is associated with the first communication communicated with the first user over the OCN.

According to some embodiments, the processor may be configured to receive the set of predefined rules and control the communication of the at least one user over the at least one communication network, according to the set of predefined rules and according to the stored user data.

The processor may be configured to create or generate at least one data thread. The thread may include data relating to at least one of: a subject, of at least one communication over the OCN; content of said at least one communication; context of said at least one communication; and an identity of at least two users that are related to the at least one communication.

The content of the thread may be stored in a thread database and may be accessible by at least one user that is related to the at least one communication over the OCN.

According to some embodiments, the thread may associate between two or more communications. For example, the thread may include data (e.g., a first subject) relating to a first message (e.g., a text message) and may also include data (e.g., a second subject) relating to a second communication (e.g., a voice message). The thread may thus be related to as associating the first communication and the second communication.

In some embodiments, the two associated communications may be communicated over different communication networks and/or protocols. For example, the first messages may be is communicated over a first ECN, through a first communication protocol and the second message may be communicated over a second ECN through a second communication protocol. In another example, the second message may be communicated over the OCN, through an OCN communication protocol.

The thread may include data relating to information stored on at least one organizational directory service database (e.g., an active directory database), and changes made to entries of the organizational directory service may be reflected in the content of the thread.

The thread may include data relating to information stored on at least one organizational database, such as a Customer Relations Management (CRM) database, and changes made to entries of the organizational database may be reflected in the content of the thread, and changes made in the content of the thread may be reflected in the organizational database.

According to some embodiments, the processor may be configured to display a personalized, context based user interface (CBUI), on a computing device of the first user to allow the first user to access data relating to at least one thread, according to access permissions attributed to the first user.

According to some embodiments, the information displayed on the CBUI may be context driven, according to a predefined set of triggering events, and may be personalized according to one or more membership properties, as explained herein.

The processor may be configured to enable computing devices of a first user and the at least one second user associated with at least one thread to display, via the CBUI, information relating to the thread. The processor may be configured to enable the first user and the at least one second user to interact with the thread, including for example sending and receiving communications over the OCN and communicating by a voice-call over the OCN.

According to some embodiments, the processor may be configured to display the CBUI on a user's computing device according to a triggering event from a predefined list of triggering events including at least one of: connection of the user's computing device to the OCN; a change relating to the user on an organizational database; a change made to a thread, to which the user is associated; an incoming or outgoing communication on the OCN, to which the user is associated; and an incoming or outgoing communication on an external network, to which the user is associated.

Embodiments of the present invention include a method for managing communication between users of computing devices over an OCN, including: storing user data relating to at least one user, and transferring communication among computing devices within the OCN, according to the stored user data and according to a set of predefined rules.

Some embodiments may include transferring communication between the OCN and at least one ECN according to the stored user data and according to a set of predefined rules.

Embodiments of the method may include performing protocol conversion of communication between a first communication protocol of the OCN and a second protocol of at least one ECN according to the stored user data.

The stored user-data may include data relating to for example, one or more of a first user's identity, the first user's role in the organization, and access-permissions attributed to the first user.

The stored user data may include data relating to a first communication with a first user over the OCN, including at least one of the first communication's subject, the first communication's content, the first communication's context, and at least one identity of a second user related to the communication.

Some embodiments may include creating at least one data thread. The thread may be or may include a data structure (e.g., a class, a table, a linked list and the like) that may include one or more data elements. The one or more data elements may relate to at least one of: a subject of at least one communication communicated over the OCN, a content of the at least one communication and/or a reference thereto, a context of the at least one communication (e.g., a reference to other communications) and an identity of at least two users that may be related to the at least one communication.

The content of the thread may be stored in a thread database and may be accessible by at least the two users that are related to the at least one communication via the OCN.

Embodiments of the method may include displaying a CBUI on a computing device of a user, to allow or enable the user to access data stored within the OCN according to access permissions attributed to the user. For example, a CBUI manager may personalize the appearance or presentation of one or more CBUIs on computing devices associated with respective one or more users or members in an organization. The presentation may be personalized in a sense that users may view one or more representations (e.g., icons, links and the like) of respective one or more data elements that may be included in or stored on the OCN on their computing devices (e.g., smartphones) according to at least one membership property (e.g., a role of the user in an organization). Furthermore, the presentation may be personalized in a sense that users may be allowed to interact with the one or more data elements through the one or more respective representations. Interaction with the data element may include, for example: viewing the data element, downloading or uploading the data element, acting upon the data element to establish user allowable communication with another user or device, communicating the data element to another user, deleting the data element from storage, and the like.

Embodiments may include displaying the information on the CBUI according to context driven, and according to a predefined set of triggering events.

Embodiments may include enabling computing devices of a first user and at least one second user associated with at least one thread, to display information via the CBUI, relating to the thread. Embodiments may enable the first user and the at least one second user to interact with the thread, including for example sending and receiving communications (e.g., text message, emails, etc.) over the OCN and communicating by a voice-call over the OCN.

Embodiments may include for example:
associating the CBUI with a first thread;
associating the first thread with a first user and at least one second user;
enabling computing devices of the first user and the at least one second user to display the CBUI; and
allowing the first user and the at least one second user to access stored user data according to respective access-permissions attributed to the first and second users.

Some embodiments may include enabling communication or interaction between the first and at least one second user regarding a thread. The interaction may be selected from a list including at least one of:
sending and receiving data messages over the OCN;
sending and receiving data messages over at least one ECN;
conducting voice and/or video communication over the OCN; and
conducting voice and/or video communication over at least one ECN.

Embodiments of the present invention may include a method of managing communication of at least one user of at least one respective first computing device over an organizational communication network (OCN). Embodiments of the method may include:
receiving an indication of occurrence of a triggering event related to the at least one user, wherein the indication may include at least one trigger property,
generating a thread, including at least one thread data element based on the at least one trigger property,
attributing a membership property to the at least one user;
presenting the at least one thread data element on a context-based user interface (CBUI) of the at least one first computing device according to at least one of the membership property and the trigger property, and
enabling the at least one user to perform at least one action over the OCN, in the context of the thread representation on the UI, based on the at least one thread data element and the membership property.

At least one membership property may be selected from a list including: an identification of the user, the at least one user's role in an organization, pertinence of the user to a specific group in the organization, one or more permissions attributed to the at least one user and one or more data elements relating to a computing device associated with the at least one user.

At least one trigger property may be selected from a list including one or more of: a connection of a computing device to the OCN, disconnection of a computing device from the OCN, an action taken by at least one user on the OCN, changes made to entries or values of an organizational database, a scope of a triggering event and a priority of a triggering event.

According to some embodiments, at least one thread data element may be a representation of a data element stored on a computing device on the OCN, and the action may be an interaction, selected from a list including: viewing the stored data element, retrieving the stored data element, modifying the stored data element and deleting the stored data element.

Enabling the user to perform the action may be based on at least one membership property. For example, a membership property may include a permission or prohibition to a respective user to access a data element stored on a computing device on the OCN, and the user may be allowed or disallowed to access (e.g., download) the data element accordingly.

At least one thread data element may be a representation of at least one second computing device on the OCN, and the at least one action may be a communication action between the first computing device (e.g., the user's smartphone) and the at least one second computing device, such as a smartphone of a second user connected to the OCN, a storage server included in or connected to the OCN and/or a network node (e.g., a switch, a router, a gateway, etc.) connected to the OCN.

At least one thread data element may be a representation of at least one second user connected to the OCN, and the at least one action may be a communication action between the first computing device of the respective first user (e.g., the user's smartphone) and the at least one second computing device of the respective second user, such as a smartphone of a second user connected to the OCN.

Embodiments of the method may include presenting the thread on the CBUI of the first computing device and on the CBUI of the at least one second computing device. For example, a thread that may including one or more thread data elements that are common to the user of the first computing device and the user of the second computing device may be presented on the CBUI of the first computing device and on the CBUI of the second computing device.

According to some embodiments, the communication action may be selected from a list including: sending a synchronous communication, receiving a synchronous communication, sending an asynchronous communication, receiving an asynchronous communication, propagating a communication via nodes of the OCN and blocking a propagation of a communication via nodes of the OCN, and wherein enabling the user to perform the communication action may be based on at least one membership property.

According to some embodiments, the CBUI of the at least one computing device of a respective first user may present the presentation of only the at least one second user the first user is allowed to communicate with over the OCN, and allow only the at least one communication action type the first user is allowed to with respect to the second user.

According to some embodiments, the CBUI of the at least one computing device of a respective first user may present the presentation of only the at least one second computing device the first user is allowed to communicate with over the OCN, and allow only the at least one communication action type the first user is allowed to with respect to the second computing device.

Embodiments of the method may include analyzing one or more communications over the OCN, to extract one or more communication properties therefrom. The one or more communication properties may be selected from a list including: a communication protocol, a communication subject, a communication content, a communication context, an identity of one or more users that are related to the at least one communication and a membership property of the one or more users related to the at least one communication.

Embodiments of the method may include assigning a value of an extracted communication property of one or more communications to a respective thread data element of a specific thread, so as to associate between the one or more communications and the specific thread.

Embodiments of the method may include assigning a value of an extracted communication property of two or more communications to a respective thread data element of a specific thread, so as to associate between the two or more communications and the specific thread, where the two or more communications may differ in at least one of a communication type and a communication protocol.

For example, a first communication (e.g., a video conference) that may have a first protocol (e.g., a synchronous voice communication protocol) may concern a specific subject (e.g., where a specific word or phrase defining the subject has been uttered by one or more of the participants) and may be associated, included or referred to by a specific thread, a second communication (e.g., an email) that may have a second protocol (e.g., an asynchronous text data communication protocol) and may concern the same subject (e.g., where a specific word or phrase defining the subject has been included in the text of the email) may be associated, included or referred to by the same specific thread, and may thus also be associated with the first communication.

The one or more specific communications may be represented as part of the respective, associated one or more specific threads on the CBUI. For example, the thread may be represented as a tab on the CBUI, and may include icons, links, etc. that may represent respective one or more communications.

According to some embodiments, the OCN interfaces with one or more external communication networks (ECNs) using an ECN communication protocol. Embodiments may propagate a communication via nodes of the OCN by an OCN unified communication protocol, as elaborated herein.

The one or more ECNs may be selected from a group including: a Wide Area Network (WAN), a metropolitan area network (MAN), an Enterprise Private Network (EPN), a Virtual Private network (VPN), a Local Area Network (LAN), a cellular network, a Public Switched Telephone Network (PSTN), a satellite communication network, an Internet of Things (IoT) network, a machine to machine (M2M) network, and third-party (e.g., proprietary) communication networks.

At least one ECN communication protocol may be selected from a group including: Open Systems Interconnection (OSI) protocols, TCP/IP protocols, Voice over Internet Protocol (VoI), Public Switched Telephone Network (PSTN) protocol, email messaging protocols, cellular communication protocols, cellular text messaging protocols, and third-party and proprietary communication protocols.

Embodiments of the present invention may include:
receiving at least one communication from a computing device of an ECN, in an ECN communication protocol;
converting the ECN communication protocol of the received ECN communication to a unified OCN protocol; and
propagating the communication via nodes of the OCN in the unified OCN protocol.

Embodiments of the present invention may include:
receiving at least one communication from a computing device of the OCN, in a unified OCN communication protocol;
converting the unified OCN communication protocol of the received OCN communication to an ECN protocol; and
propagating the communication to a computing device of the ECN.

According to some embodiments, at least one thread may be stored in a thread database and may be accessible via the OCN by the one or more users that may be related to the at least one thread. For example, a user may be a member of a specific group in the organization. The user's identification may thus be included in a thread that includes communications concerning the group. The user may thus be enabled to access at least one communication (e.g., read a message) that may have been communicated between two other members of the group.

According to some embodiments, performing an action over the OCN may include one or more of:
enabling a user to select at least one thread and one or more respective actions via the CBUI;
instructing at least one node of the OCN to perform the action according to the user's selection;
updating the thread database according to the at least one performed action; and
updating the thread representation on the CBUI of one or more users related to the thread.

According to some embodiments, at least one action may be an administrative thread action, selected from a list including at least one of: initiating a thread, archiving a thread, deleting a thread and propagating a thread to one or more computing devices on the OCN. Embodiments may enabling the user to perform the administrative thread action based on at least one membership property. For example, a user may have a membership property that includes a definition of themselves as a high-profile (e.g. an administrator) user in the organization may be enabled by embodiments of the invention to perform one or more administrative thread actions as elaborated herein. This may include for example propagating a content of a thread (e.g., a communication such as text message) through the OCN (e.g., between two users of computing devices) or preventing or blocking such propagation (e.g., between a first user, connected to the OCN and a second user connected to an ECN).

Embodiments of the present invention may include method of managing communication of at least one user of a respective at least one first computing device over at least one organizational communication network (OCN). Embodiments of the method may include:
receiving an indication of occurrence of a triggering event related to the at least one user,
receiving a membership property of the at least one user, and
presenting a context-based user interface (CBUI) on the at least one first computing device according to the triggering event, where the presentation of the CBUI may be personalized according to the membership property.
   For example, a first user having a first membership property may be presented on the CBUI a first set of thread data elements and respective optional actions and a second user having a second membership property may be presented on the CBUI a second set of thread data elements and respective optional actions.

The membership property may be selected from a list including: an identification of the user, the user's role in an organization, pertinence of the user to a specific group in the organization, one or more permissions attributed to the at least one user and one or more data elements relating to a computing device associated with the at least one user.

Embodiments of the present invention may include:
generating a thread, including at least one thread data element based on the triggering event;
presenting the thread on the CBUI according to the membership property; and
enabling the at least one user to perform at least one action over the at least one OCN, in the context of the thread representation on the UI, based on the at least one thread data element and the membership property, as elaborated herein.

The at least one thread data element may be selected from a list including: one or more communication properties of at least one communication over the OCN, one or more representations of a data element that may be stored on a computing device on the at least one OCN and one or more triggering properties of the triggering event.

The one or more communication properties may be selected from a list including: a subject of a communication, a content of a communication, a reference to a content of a communication, a context of the communication, one or more parameters relating to an identity of at least one user related to the communication, and one or more parameters relating to an identity of at least one computing device related to the communication.

According to some embodiments, the at least one OCN may include a plurality of OCNs. Embodiments of the present invention may further include presenting a respective plurality of CBUIs on the at least one first computing device, according to a context of the triggering event, wherein each presentation of a CBUI may be personalized according to the membership property of the at least one user in relation to the respective OCN, as elaborated herein.

Embodiments of the present invention may include a system for managing communication of at least one user of at least one respective first computing device over an organizational communication network (OCN). Embodiments of the system may include: a non-transitory memory device, wherein modules of instruction code are stored, and a processor associated with the memory device, and configured to execute the modules of instruction code. Upon execution of the modules of instruction code, the processor may be further configured to perform at least one of:
receive an indication of occurrence of a triggering event related to the at least one user, wherein the indication includes at least one trigger property,
generate a thread, including at least one thread data element based on the at least one trigger property,
attribute a membership property to the at least one user;
present the at least one thread data element on a CBUI of the at least one first computing device according to at least one of the membership property and the trigger property; and
enable the at least one user to perform at least one action over the OCN, in the context of the thread representation on the UI, based on the at least one thread data element and the membership property.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram depicting a computing device, which may be included within an embodiment of a system for managing organizational communication networks, according to some embodiments

FIG. 2 is a schematic block diagram depicting a system for managing communication between users of computing devices over an organizational communication network, according to some embodiments;

FIG. 3 is a schematic block diagram depicting an OCN manager, that may be included in a system for controlling communication on an OCN;

FIG. 4 is a flow diagram depicting an example of a method for managing communication over OCN according to some embodiments;

FIG. 5A presents a flow diagram, elaborating an example of directing data messages through an Organizational Communication Network (OCN), and creation of a respective thread, according to some embodiments;

FIG. 5B presents a flow diagram, depicting an example of directing voice communication between two computing devices within the OCN, over an Organizational Communication Network Voice Protocol (OCN-VP);

FIG. 5C presents a flow diagram, elaborating an example of voice communication routing through an OCN, and creation of a respective thread, according to some embodiments; and

FIG. 6 is a schematic example of a context based user interface that may be included in a system for controlling communication on an OCN, according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, rumerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention may include a method and a system for managing communication between users of computing devices (e.g. smartphones, tablet computers, laptops and the like) over an organizational communication network (OCN). Embodiments of the system may be configured to facilitate a wide variety of capabilities. For example, according to some embodiments, the system may facilitate at least one of:
aggregating data relating to various types of communication over the OCN, including voice, video and messaging communication into threads;
providing a dynamic, unified, context based user interface (CBUI) for members of the organization, to enable interaction with other members of the organization, in relation to the threads, and according to individual members' organizational roles and predefined permissions;
providing an administrative interface for central, cloud-based control of the OCN, to define the OCN members' communications schemes, groups, access rights and privileges, trigger events and personalized UIs, to apply policies of data security, distribution and auditing over the OCN; and
enabling members of the organization to interact or communicate with users of external voice and messaging networks via the controlled OCN.

The following table, Table 1 includes a description of terms used herein.

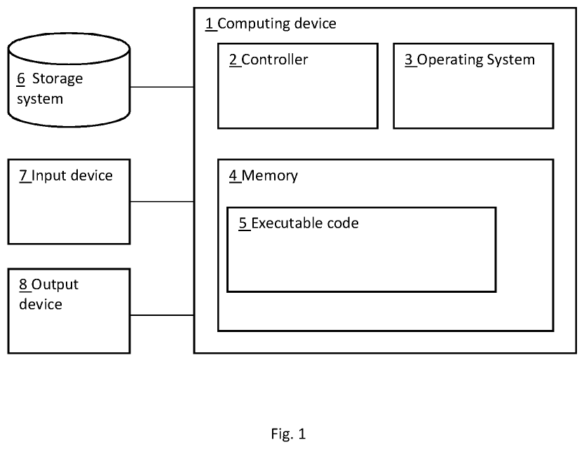

TABLE 1

| | |
|---|---|
| Communication | The term ‘communication’ may be used herein to refer to a transfer of |
| | data between two or more computing devices, and may refer to data |
| | transfer of a plurality of types (e.g., synchronous communication |
| | types and asynchronous communication types) and/or protocols, |
| | including for example data (e.g., machine-to-machine), |
| | communication protocol, text communication (e.g., email) protocols, |
| | voice communication protocols, video communication protocols and |
| | audiovisual communication protocols. |
| Communication | The term “communication property” may be used herein to refer to, |
| property | for example, a subject of a communication, a content of a |
| | communication, a reference (e.g., a pointer) to a content of a |
| | communication, a context of the communication (e.g., occurrence of |
| | the communication during, following or in response to occurrence of |
| | another event or communication), and one or more parameters |
| | relating to an identity of at least one user (e.g., a name, an email |
| | address and the like) and/or computing device (e.g., a MAC address, |
| | an IP address and the like) related to the communication. For |
| | example, such properties may be metadata. |
| Node | The term ‘node’ may be used herein to refer to a computing device |
| | (e.g., element 1 of FIG. 1) that may be interconnected with other nodes |
| | to form a communication network, as known in the art. |
| Organizational | The term OCN may be used herein to refer to a communication |
| Communication | network including a plurality of nodes, where the nodes are associated |
| Network | with or included in an organization. For example, the OCN may |
| (OCN) | include one or more computing devices that may be included in a |
| | computational infrastructure of the organization. In another example, |
| | the OCN may include one or more computing devices (e.g., a |
| | smartphone) that may be ad-hoc communicatively connected to other |
| | organizational nodes (e.g., a Wi-Fi communication -router). |
| External | The term ECN may be used herein to refer to one or more |
| Communication | communication networks including a plurality of nodes, where the |
| Network (ECN) | nodes are not associated with or included in the organization of the |
| | OCN. |
| Member, user | The terms ‘Member’ (e.g., in the context of a member of an |
| | organization) and ‘User’ may be used interchangeably herein to refer |
| | to an entity (e.g. a user of a computing device and/or the computing |
| | device itself), that may be connected to the OCN. |
| | The user may be granted or attributed specific access permissions to |
| | communicate with other nodes and/or entities through the OCN, |
| | including for example other members, storage devices, |
| | communication devices, computer servers and the like. |
| | In some embodiments, members may be registered in a directory |
| | service (e.g. an active directory server) of the organization and may |
| | be attributed or assigned access permissions according to their role in |
| | the organization (e.g., guest users, functional users, administrators, |
| | etc.). |
| Membership | The term membership property may be used herein to refer to at least |
| property | one characteristic of the user, including for example: an identification |
| | of the user, the at least one user's role in an organization, pertinence |
| | of the user to a specific group in the organization, one or more |
| | permissions attributed to the at least one user and one or more data |
| | elements relating to a computing device associated with the at least |
| | one user. |
| Thread | The term ‘thread’ may be used herein to refer to an event-driven, |
| | dynamic data structure that may relate to a specific subject. |
| | A thread may be represented on a context-based user interface |
| | (CBUI) of one or more user devices, thus enabling the respective |
| | users to interact among themselves, communicate among themselves |
| | and/or communicate with computing devices via the OCN, in the |
| | context of the presented thread on the CBUI, as elaborated herein. |
| | A thread may include one or more thread data elements that may be |
| | or may include, for example: one or more communication properties |
| | as elaborated herein, one or more representations (e.g., a pointer or |
| | reference to) a data element that may be stored on a computing device |
| | on the OCN, and one or more triggering properties of a trigger event, |
| | as elaborated herein. |
| | For example, a thread data element may include at least one |
| | communication property of a communication of a member of the |
| | organization with another entity (e.g. another member of the |
| | organization, a user of an ECN, an organizational data storage system, |
| | etc.). A thread may encompass or associate a plurality of |
| | communications that may have common or related communication |
| | properties (e.g., a common subject, common participants, etc.) |
| | The term ‘thread’ has been selected to imply a data structure that may |
| | dynamically describe or represent a relation of one or more users to a |
| | specific subject or issue that may be communicated, stored and/or |
| | discussed through the OCN over time. |
| | A thread may be dynamic in the sense that its content may change or |
| | evolve over time according to or in response to occurrence of one or |
| | more triggering events, as elaborated herein. |
| Context Based | The term Context Based User Interface (CBUI) may be used herein to |
| User Interface | refer to a user interface (UI) that may be presented on at least one |
| (CBUI) | computing device (e.g., a smartphone) associated with or belonging to |
| | a specific user. |
| | The CBUI may be context-based in a sense that its presentation on the |
| | user's computing device may be presented, omitted and/or changed |
| | according to a context of a triggering event, as explained herein. |
| | The CBUI may be personalized, in a sense that its presentation may |
| | be presented, omitted and/or changed according to at least one |
| | membership property (e.g., a role in the organization) of the |
| | respective user. |
| | The CBUI may be further personalized, in a sense that its presentation |
| | on the user's computing device may facilitate or enable at least one |
| | action and/or communication according to at least one membership |
| | property, such as a permission attributed to the respective user. |
| Triggering | The term triggering event may be used herein to refer to an event that |
| event, Trigger | may induce creation, deletion or a change of a thread. For example, a |
| property | triggering event may be selected from a list including a connection of |
| | a computing device to the OCN, a disconnection of a computing |
| | device from the OCN, changes to entries or values in a database, |
| | occurrence of an external event (e.g., elapse of a predefined time |
| | period), and an action taken by at least one user (e.g., performing a |
| | communication over the OCN) |
| | A trigger property may include, for example, the cause or origin of a |
| | trigger as elaborated above (e.g., connection of a computing device to |
| | the OCN), a scope of a triggering event (e.g., relevance of the trigger |
| | to specific threads), a priority of the trigger (e.g., reception of an |
| | important email), and the like. |
| Machine | The term machine learning may refer to an information processing |
| Learning | paradigm that may include nodes, referred to as neurons, organized |
| | into layers, with links between the neurons. The links may transfer |
| | signals between neurons and may be associated with weights. |
| | A neural network (NN) may be configured or trained for a specific |
| | task, e.g., pattern recognition or classification. Training a NN for the |
| | specific task may involve adjusting these weights based on examples. |
| | Each neuron of an intermediate or last layer may receive an input |
| | signal, e.g., a weighted sum of output signals from other neurons, and |
| | may process the input signal using a linear or nonlinear function (e.g., |
| | an activation function). The results of the input and intermediate |
| | layers may be transferred to other neurons and the results of the |
| | output layer may be provided as the output of the NN. Typically, the |
| | neurons and links within a NN are represented by mathematical |
| | constructs, such as activation functions and matrices of data elements |
| | and weights. A processor, e.g. CPUs or graphics processing units |
| | (GPUs), or a dedicated hardware device may perform the relevant |
| | calculations. |

Reference is now made to FIG. 1, which is a block diagram depicting a computing device, which may be included within an embodiment of a system for managing organizational communication networks, according to some embodiments.

Computing device 1 may include a controller 2 that may be, for example, a central processing unit (CPU) processor, a chip or any suitable computing or computing device, an operating system 3, a memory 4, executable code 5, a storage system 6, input devices 7 and output devices 8. Controller 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of, possibly different memory units. Memory 4 may be a computer or processor non-transitory readable medium, or a computer non-transitory storage medium, e.g., a RAM.

Executable code 5 may be any executable code, e.g., an application, a program, a process, task or script. Executable code 5 may be executed by controller 2 possibly under control of operating system 3. For example, executable code 5 may be an application that may manage organizational communication networks as further described herein. Although, for the sake of clarity, a single item of executable code 5 is shown in FIG. 1, a system according to some embodiments of the invention may include a plurality of executable code segments similar to executable code 5 that may be loaded into memory 4 and cause controller 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Content may be stored in storage system 6 and may be loaded from storage system 6 into memory 4 where it may be processed by controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., controllers similar to controller 2), a plurality of input units, a plurality of output units, a plurality of memory units, and a plurality of storage units.

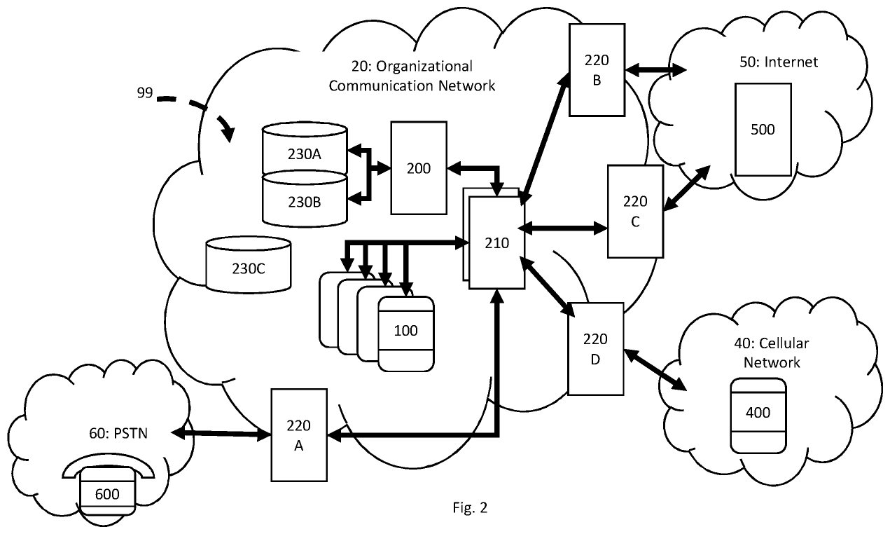

Reference is now made to FIG. 2, which is a schematic block diagram depicting a system 99 for managing communication between users of computing devices over an organizational communication network (OCN) 20, according to some embodiments.

As shown in FIG. 2, the OCN may interface with or may be connected to one or more external communication networks (ECNs, e.g., elements 40, 50 and 60). System 99 may be configured manage the routing or communication between computing devices that may be connected to, or included in at least one communication network, including OCN 20 and/or one or more ECNs (40, 50 and 60), as explained herein.

In one embodiment, OCN 20 may be proprietary of a specific organization (e.g., a company, a forum or a gathering of people such as a conference, and the like), and may include one or more computing devices 100 (e.g., smartphones, laptops and the like), that may belong to individuals who may be members of the organization (hereinafter user devices 100).

System 99 may facilitate communication (a) among users devices 100, (b) between user devices 100 and other computing devices included in OCN 20 and/or (c) between users devices 100 and other computing devices (e.g., 400, 500, 600) pertaining to ECNs (e.g., 40, 50, 60 respectively). System 99 may facilitate this communication and display content on user devices 100 pertaining to the parties of the communication according to respective specific user data, such as properties of the user's membership in the organization, as explained herein.

According to some embodiments, system 99 may include one or more nodes (e.g., 200, 210, 220A-220D) which may be or may include at least one computing device, such as element 1 of FIG. 1. The one or more nodes may include at least one non-transitory memory device (e.g., element 4 of FIG. 1) upon which computer-readable instruction code modules are stored (e.g., element 5 of FIG. 1), and at least one processor (e.g., element 2 of FIG. 1), associated with the non-transitory memory device, and configured to execute the stored instruction code modules, to implement the functionality of system 99, as described herein.

According to some embodiments, at least one node of system 99 may be an OCN manager module (e.g., 200) and one or more nodes of system 99 may be communication modules (e.g., 210, 220A, 220B, 220C, 220D) associated with OCN manager module 200 and configured to transfer communication between computing devices over OCN 20.

In some embodiments, OCN manager module 200 may be configured to monitor, analyze and/or control communication over OCN 20.

For example, OCN manager module 200 may be configured to control the operation of the one or more communication modules (e.g., 210, 220A, 220B, 220C, 220D) so as to configure and/or regulate the traffic of communication through OCN 20, as elaborated herein.

The term ‘thread’ may refer herein to an event-driven, dynamic data structure, that may relate to a specific subject, and to at least one communication of a member of the organization with another entity (e.g. another member of the organization, a user of an external communication network, organizational data storage systems, etc.).

Threads may be characterized by a set of predefined parameters. For example, according to some embodiments, threads may be characterized by at least one of: tread subject; tread type (e.g. thread that relates to a text message or a VOIP communication); data stored in or referred to by the tread, including at least one of: a subject of at least one communication over the OCN; content of the at least one communication; context of said at least one communication (e.g., timing, relation to other communications over the OCN, etc.); and identity of at least two users that are related to the at least one communication.

Additionally, or alternatively, threads may be characterized by one or more of: events that trigger the creation of a thread (e.g., connection of a computing device to an OCN, reception or transmission of a communication over the OCN, etc.) and events that trigger the deletion of a thread (e.g., disconnection of a computing device from an OCN, an action taken by a member of the organization, signaling that the thread's subject has been handled etc.).

OCN manager module 200 may be configured to monitor the communication over OCN 20 (e.g., to and/or from one or more user devices 100), analyze the monitored communication and arrange or aggregate related communications into threads. OCN manager module 200 may display the threads on a CBUI on the respective user devices 100 and may enable users to interact with one another according to the displayed threads, as explained herein.

According to some embodiments, system 99 may include a member database 230A, where at least one user data element, such as a membership property of a user may be stored. The user data or membership property may include, for example: the user's name, the user's role in an organization, one or more permissions attributed to the user, one or more data elements relating to a computing device (e.g., user device 100) belonging to or associated with the user (e.g., a phone number, a MAC address, an internet protocol (IP) address and the like).

According to some embodiments, one or more communication modules (e.g., 210, 220) may include at least one communication switch (e.g., 210), associated with or communicatively connected to OCN manager module 200. OCN manager module 200 may be configured to instruct the at least one switch 210 to switch or block one or more communications (e.g., data, voice and/or audiovisual communication) within OCN 20 between at least two computing devices.

For example, OCN manager module 200 may instruct switch 210 to switch a communication (e.g., an email message) originating from a computing device (e.g., an email server, such as element 500) residing on an ECN (e.g., internet 50) to a user device 100 that may be connected to OCN 20, as known in the art. Alternately, OCN manager module 200 may instruct switch 210 to block the transfer of the communicated message, as known in the art.

In some embodiments, the instruction of OCN manager module 200 to one or more communication devices (e.g., 210, 220) may be based on at least one of: (a) a user data element, such as a membership property (e.g., stored on 230A) and (b) one or more predefined rules, as elaborated herein.

According to some embodiments, OCN 20 may be configured to propagate or transfer communication of one or more types or protocols. The types or protocols of communication may include, for example:

asynchronous data communication (e.g., a message from one computing device to another that may not require acknowledgement);

asynchronous audio communication (e.g., an audio stream, an audio message and the like);

asynchronous video communication (e.g., a video stream);

asynchronous audiovisual communication (e.g., a recorded audiovisual message);

synchronous data communication (e.g., a data message from one computing device to another that may require an acknowledgement);

synchronous audio communication (e.g., an audio discussion);

synchronous video communication (e.g., a live video stream); and

synchronous audiovisual communication (e.g.; a video conference).

As shown In FIG. 2, system 99 may be configured to interface with one or more ECNs. The one or more ECNs may be selected from a list including one or more types, such as: a Wide Area Network (WAN), a Metropolitan Area Network (MAN), an Enterprise Private Network (EPN), a Virtual Private network (VPN), a Local Area Network (LAN), a Cellular network, a Public Switched Telephone Network (PSTN), a Satellite communication network, an Internet of Things (IoT) network, and a Machine to Machine (M2M) network.

The ECN's communication protocol may be selected according to the type and may include for example: an Open Systems Interconnection (OSI) protocol (e.g. TCP/IP, UDP, HTP, and the like), a Voice over Internet Protocol (VoIP), a Public Switched Telephone Network (PSTN) protocol, an email messaging protocol (e.g. SMTP), a cellular communication protocol, a cellular messaging protocol (e.g., SMS, MMS), and proprietary (e.g., third-party) messaging protocols (e.g., WhatsApp).

According to some embodiments, system 99 may be configured to propagate communications through OCN 20 by a unified OCN communication protocol. The OCN communication protocol may be unified in a sense that it may include the communicated data or payload that may originate from a plurality of sources and/or protocols in a single data structure, envelope or format, as known in the art.

For example, voice communication may be propagated or transmitted between computing device nodes of OCN 20 (e.g., between switch 210 and user device 100) using a unified OCN voice communication protocol (OCN-VP) and be directed through the OCN by one or more dedicated OCN-VP switches 210.

In another example, data communication may be propagated or transmitted between computing device nodes of OCN 20 (e.g., between switch 210 and user device 100) using a unified OCN data communication protocol (OCN-DP), and be directed through the OCN by one or more dedicated OCN-DP switches 210.

According to some embodiments, OCN 20 may interface with at least one ECN via one or more dedicated gateway or router 220 (e.g., 220A, 220B, 220C, 220D) that may be controlled by OCN manager 200. OCN manager 200 may instruct the one or more dedicated gateway or router 220 to perform a conversion of protocols between at least one communication protocol of the interfaced ECN and a unified OCN protocol.

For example, the one or more dedicated gateway or router 220 may be configured to extract a data payload of a communication received from an ECN, and envelope the data payload so as to form an OCN communication frame or packet, as known in the art. In the opposite direction, the one or more dedicated gateway or router 220 may be configured to extract a data payload of an OCN communication, and envelope the data payload so as to form an ECN communication frame or packet, as known in the art.

The unification of data communication may facilitate storage, analysis and or presentation of communications originating from different sources and using different protocols, as explained herein.

In some embodiments, OCN manager 200 may instruct at least one gateway 220 to perform a protocol conversion of data communication between the unified OCN data communication protocol(OCN-DP) and one or more data protocols of at least one ECN.

For example, a first user device 100 may be connected to the OCN 20 and may require email services from an external (e.g., pertaining to an ECN) SMTP email server (e.g., element 500) on the Internet 50. OCN manager 200 may instruct a dedicated gateway (e.g., 220B) to perform a conversion of data protocol between the SMTP data protocol and the unified OCN data protocol OCN-DP. Thus, the user may send and/or receive email messages to and/or from SMTP email server 500 via OCN 20.

In another example, a second user device 400 may be connected to a cellular network 40, and may send another communication (e.g., a second text message) to the first user device 100, via a third-party proprietary text application (e.g., Windows messenger) that may use a different protocol than that of SMTP server 500. OCN manager 200 may instruct dedicated gateway 220B to perform a conversion of data protocol between the third-party proprietary protocol and the unified OCN-DP protocol.

According to some embodiments, the processor 200 may be configured to perform protocol conversion of voice communication between the OCN voice communication protocol (OCN-VP) and a voice communication protocol of at least one ECN.

For example, a first user device 100 may receive or may initiate a synchronous voice communication, such as a phone call to a second user device 400 connected to a cellular network 40. According to some embodiments, OCN manager 200 may instruct a dedicated gateway 220D to perform a conversion between the cellular voice communication protocol and a unified OCN voice communication protocol, OCN-VP. The voice communication may then be propagated or routed through OCN 20 (e.g., via a dedicated switch 210), using the unified OCN-VP protocol.

In another example, a first user device 100 may receive an asynchronous audiovisual communication, such as a video stream from a server (e.g., 500) on the internet 50. OCN manager 200 may instruct a dedicated gateway 220C to perform a conversion between the video stream protocol and a unified OCN audiovisual protocol, OCN-AVP. Asynchronous audiovisual communication may then be propagated or ruted through OCN 20 (e.g., via a dedicated switch 210), using the unified OCN-AVP protocol.

According to some embodiments, conversion of data communication protocol may be performed according to or dependent on at least one of a user data element such as a membership property, a thread data element and a predefined rule. For example, OCN manager 200 may instruct at least one dedicated gateway (e.g., 220D) to deny access from specific user devices 100 via OCN 20 to one or more ECNs (e.g., cellular network 40). In another example, OCN manager 200 may instruct at least one dedicated gateway (e.g., 220B) to prevent propagation of a specific communication, having a specific subject to at least one ECN (e.g., internet 50).

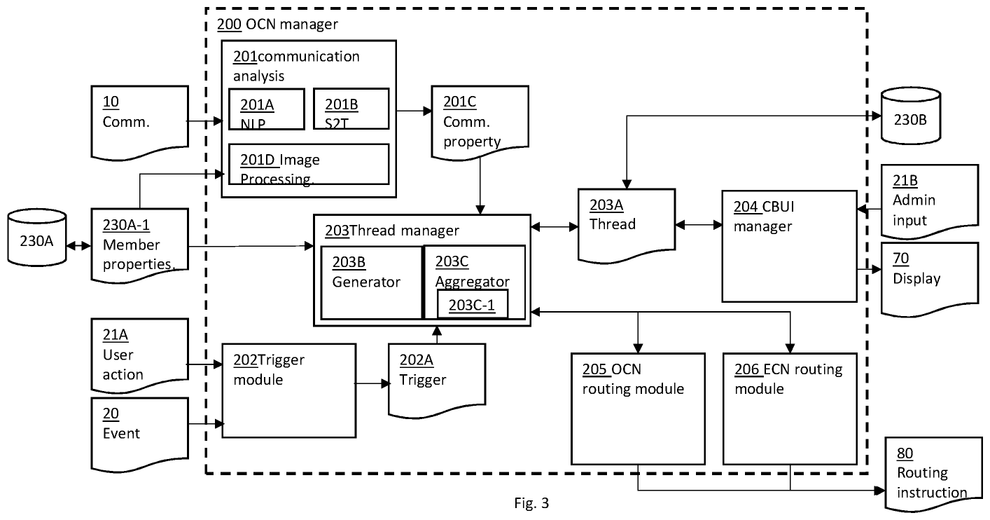

According to some embodiments, OCN manager 200 may be configured to analyze one or more communications over the OCN, so as to extract or determine one or more communication properties therefrom, as elaborated herein, in relation to FIG. 3. The one or more extracted communication properties may be for example:

a communication protocol (e.g., a synchronous voice protocol, an asynchronous data protocol and the like);

a communication subject (e.g., a subject of an email, a title of a video stream and the like);

a communication content (e.g., a payload of a communication packet) or a reference (e.g., a pointer to a storage location) thereto;

a portion of a communication content (e.g., a phrase in an audio stream) and/or a reference thereto;

a communication context (e.g., a time of day, an existence of another, associated communication);

an identity of one or more users that are related to the at least one communication (e.g., two users participating in a phone call, a list of participants in an email correspondence, etc.); and

a user data element, such as a membership property of the one or more users (e.g., a role of the user in the organization, etc.) related to the at least one communication.

According to some embodiments, system 99 may include a thread database 230B, configured to store thread data elements relating to communication of users over OCN 20. Thread data elements may include, for example, one or more communication properties as elaborated herein (e.g., a subject of a communication, a content of the communication, a context of the communication, and parameters relating to an identity of at least one other user related to the communication, etc.).

Reference is now made to FIG. 3, which is a schematic block diagram depicting an OCN manager 200 that may be included in a system 99 for controlling communication on an OCN (e.g., element 20 of FIG. 2).

According to some embodiments, system 99 may create, modify and delete threads dynamically according to predefined triggers. The triggers may occur automatically, or in response to an occurrence of a predefined event, or as a response to an action taken by members of the OCN, as explained herein.

According to some embodiments, OCN manager 200 may include a trigger module 202, configured to receive or detect an indication or notification of occurrence of a triggering event that may be related to the at least one user, and produce a trigger signal 202A therefrom.

The triggering event indication may, for example be related to a real world event 220 relating to user device 100, including for example a connection to or disconnection from OCN 20. Alternately, the triggering event indication or notification may be an indication of a user action 21A, such as transmission of a communication (e.g., sending a text message) over OCN 20, or an administrative thread action, as elaborated herein.

Trigger signal 202A may include at least one trigger property. Pertaining to the above examples, the trigger property may include the cause or origin of each trigger, including for example a connection of computing device 100 to the OCN, disconnection of computing device 100 from the OCN and an action 21A taken by at least one user.

Thread manager module 203 may receive trigger 202A from trigger manager module 202 and may create or generate a thread, based on at least one of the membership property and trigger property. The thread may be implemented as any type of appropriate data structure known in the art (e.g., an entry in thread database 230B), and may include at least one thread data element. The thread may relate to a specific subject and may encompass or associate a plurality of communications that may have common or related communication properties (e.g., a common subject, common participants, etc.).

For example, in the case of a trigger property that is a sending of a communication (e.g., an email) between a first user device 100 and a second user device 100, the subject of the thread may be or may include the subject of the sent communication (e.g., a title of the email). As explained herein, thread manager module 203 may join or add additional communications concerning the same subject to the same thread, so as to encompass a plurality of related communications (e.g., communications including related or similar subjects). The content of the thread and the value of the thread data element may become apparent by the following explanation and examples.

Following reception of trigger signal 202A, thread manager module 203 may determine at least one identity of a user as associated with the triggering event according to the trigger property.

For example, in the case of a trigger that was generated by a user action 21A (e.g., a user sending an email from their device 100), thread manager module 203 may associated at least one of the email's senders' and/or recipients' identification with the event (e.g., the sending of the email).

In another example, in the case of a real world event 220 such as connection of user device 100 to OCN 20, thread manager module 203 may determine at least one property of user device 100 (e.g., a MAC address) as associated with the triggering event (e.g., the connection to OCN 20).

In some embodiments, thread manager module 203 may query an organizational directory service (e.g. an active directory) server to ascertain whether the determined identity corresponds with a member of the organization (e.g., OCN 20's organization). Alternately, thread manager module 203 may not recognize the user as a member of OCN 20's organization but as a guest user, having an ad-hoc connection to OCN 20.

Thread manager module 203 may query member database 230A to obtain or receive one or more membership properties therefrom (e.g., a role of the user in the organization, one or more permissions attributed to the user, etc.) and attribute or associate a membership property to the at least one user, within the context of the thread. For example, thread manager module 203 may add a link and/or an entry in the thread data structure (e.g., that may be stored on thread database 230B) to a respective membership property (e.g., a membership of a user within a group in the organization) that may be stored on member database 230A.

For example, a user who may be a member of a first group in an organization, may be attributed a first membership property in the context of a first thread that may encompass subjects relating to the first group. The first membership property may enable the user full access (e.g., read, modify, write, send, etc.) to communications associated with the first thread. Alternately, the user may be attributed a second membership property in the context of a second thread that may encompass subjects relating to a second group. The second membership property may enable the user limited access (e.g., read only) to communications associated with the second thread.

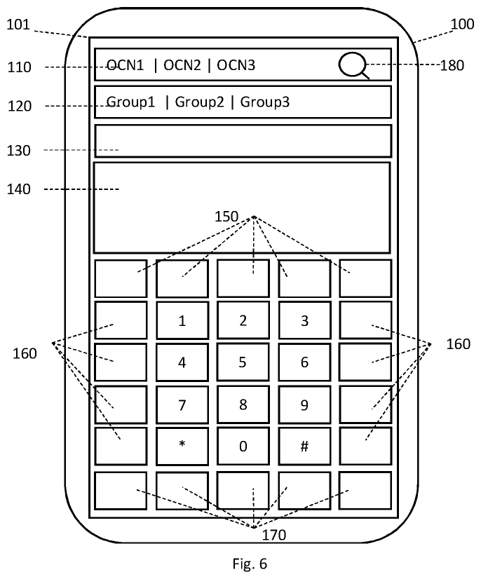

OCN manager 200 may include a CBUI manager module 204, that may be configured to present at least one thread data element of the thread on a CBUI of one or more computing device (e.g., user device 100) that may be related to the thread (e.g., pertaining to a specific trigger property). It is noted that the content and functionality of the CBUI is explained and elaborated herein in relation to FIG. 6.

CBUI manager module 204 may present the at least one thread data element according to at least one of the membership property and the trigger property.

For example, assume the triggering event is a user action 21A such as sending of a communication (e.g., a text message), concerning a specific group of users in the organization, between a first user device 100 and a second user device 100. CBUI manager 204 may present the respective thread (e.g., a reference to a content of the communication) on a CBUI of first user device 100 and second user device 100. Assume a third user is associated with a membership property that may indicate his role in the organization (e.g., a manager of the group). CBUI manager 204 may consequently present at least one thread data element (e.g., the content of the communication) on a CBUI on the computing device of the third user.

In some embodiments, OCN Manager 200 may enable at least one user (e.g., user of first user device 100) to perform at least one action over OCN 20, in the context of the thread representation on the CBUI (e.g., via the representation of the thread in the CBUI), on their user device 100, based on the at least one thread data element and the membership property. CBUI manager 204 may enable the one or more actions in one or more ways, including for example:

CBUI manager 204 may present at least one representation of the at least one thread data element only to relevant users (e.g., according to their membership properties, according to their participation in a relevant communication and the like);

CBUI manager 204 may present options for actions by graphical representations (e.g., a ‘download’ icon, a ‘delete’ icon, a ‘send’ icon, and the like) only to relevant users (e.g., according to their membership properties, according to their participation in a relevant communication and the like);

OCN Manager 200 may control one or more network elements, such as switches, routers and gateways (e.g., elements 210, 220A through 220D of FIG. 2) to allow or disallow routing of one or more a communications between a user's computing device 100 and other computing devices within OCN 20 (e.g., other computing device entities 100) and/or ECN computing devices (e.g., elements 400, 500, 600 of FIG. 2).

Pertaining to the same example, assume that a membership property of the first user includes a permission to access a file that may be stored on a computing device in the OCN, and may be associated (e.g., owned by the group). CBUI manager 204 may present a reference (e.g., a link) to the file, within a representation of the thread in the CBUI on the first user's computing device, and may enable the user to download the file therefrom (e.g., by clicking the link).

In another example, the thread data element may be an identification of the second user device 100, and may be shown (e.g., as an icon within a representation of the thread in the CBUI of all the group's members having a respective membership property). The user of first user device 100 may thus simply select to call or text the user of second user device 100 (e.g., by clicking the icon within the context of the thread).

The following examples of use-case scenarios may serve to clarify the functionality and capabilities of OCN manager module 200:

In a first use-case example, a user may arrive at an organization (e.g. a hotel) where an embodiment of system 99 may be installed. The user may connect their device 100 via an organizational wireless router (e.g., element 210) to OCN 20. Embodiments of system 99 may consequently automatically recognize the user as a guest user (e.g., not part of the organization).

Thread manager module 203 may consequently generate a thread 203A having a specific subject (e.g., the hotel's name). Thread manager module 203 may aggregate in the thread data relating to communications (e.g., text messages, emails, phone calls, etc.) that pertain to details of the user's visit (e.g., hotel ordering, amenities and check-out time). Thread manager module 203 may also assign the user a low-level membership property (e.g. as a “guest user”) in the organization. Thread manager module 203 may store the thread in any appropriate storage device, such as thread database 230B, and may update the content of stored thread when required (e.g., periodically, following occurrence of a triggering event (e.g., user action 21A, event indication 20 and the like).

CBUI manager 204 may communicate at least one content of the thread (e.g., a representation of related communications) to the user's device 100. The thread may thus be made accessible to the user via the CBUI on their user device 100, as elaborated in relation to FIG. 6.

The assigned low-level membership property may permit the user to access data that may be stored on the hotel's data storage system (e.g. the hotel's internal phonebook, selected numbers such as the front desk, the room service etc., not shown in FIG. 3). CBUI manager 204 may communicate the data (e.g., the phone numbers) to the user's device 100 as part of thread 203A, and thus enable the user to display the data on their device 100.

For example, thread 203A may include at least one thread data element that is a representation (e.g., a pointer to, or a reference) of a data element that may be stored on a computing device on the OCN (e.g., the hotel's internal phonebook). CBUI manager 204 may send the at least one thread data element to the guest's user device 100.

The CBUI on the guest's user device 100 may enable the guest user to perform at least one action (e.g., an interaction) with the presented data, according to on at least one membership property. For example, the CBUI may enable the user to view the stored data element, retrieve (e.g., download) the stored data element, modify the stored data element and delete the stored data element (e.g., from the organizational storage device), all according to the permissions granted to the user.

In another use-case example, the representation of the at least one thread data element on the CBUI of a first device 100 may enable the user to perform at least one communication action, in the context of the presented thread, and according to at least one membership property. For example, at least one thread data element may be a representation (e.g., a phone rumber) of at least one second computing device 100 on, or connected to OCN 20. A user may be permitted (according to their membership property) to perform at least one communication action between the first (e.g., their) device 100 and the at least one second device 100. The communication action may include, for example, sending and/or receiving a synchronous communication (e.g., audiovisual data of a video conference) and sending and/or receiving asynchronous communication, such as data messages, text messages, audiovisual messages and the like. Pertaining to the example of the hotel phonebook, the CBUI may enable the user to connect (e.g., initiate a phone call) with other members of the hotel (e.g., other user devices 100), within the context of the presented thread over OCN 20, as elaborated in relation to FIG. 6.

In some embodiments, CBUI manager 204 may instruct the first device 100 and the at least one second device 100 to present the thread on their respective CBUIs. For example, CBUI manager 204 may configure the CBUIs of each of the first device 100 and the at least one second device 100 to present the thread in an identical manner (e.g., to include the same presented data). Alternately, or additionally, CBUI manager 204 may configure the CBUIs of each of the first device 100 and the at least one second device 100 to present the thread differently on each user device 100, according to each respective user's membership properties (e.g., according to different privileges of data access).

In another use-case example, the user may be permitted (according to their membership property) at least one communication action such as propagating or transmitting communications via nodes of the OCN and/or blocking a propagation of communications via nodes of the OCN. For example, a high-profile user (e.g., an administrator) having a high profile membership property, may provide (e.g., via input element 7 of FIG. 1) one or more administrative inputs 21B. The administrative inputs 21B may be or may include a set of one or more rules. The one or more rules may define the capabilities of each user that is a member of OCN 20.

In the example of the hotel guest, a rule may dictate that one or more communication modules (e.g., elements 210,220 of FIG. 2) may propagate messages of a first subject to and/or from the guest, and may not propagate messages of a second subject to and/or from the guest.

In some embodiments, OCN manager 200 may include at least one of an OCN routing module 205 and an ECN routing module 206, configured to emit at least one routing instruction 80 based on the administrative inputs 21B (e.g., the set of the one or more rules). The at least one routing instruction 80 may be propagated to one or more communication modules (e.g., elements 210, 220 of FIG. 2), which may consequently propagate or block communications through OCN 20 and/or between OCN 20 and one or more ECNs, so as to implement administrative inputs 21B (e.g., the set of the one or more rules).

In another use-case example, thread manager module 203 may be configured to delete thread 203A upon occurrence of a predefined triggering event. For example, when the guest checks out of the hotel, or when the guest's smartphone is disconnected from the hotel's OCN, trigger module 202 may generate or transmit a respective trigger 202A, and thread manager module 203 may consequently delete or archive the entry of respective thread 203A in thread database 230B. CBUI manager 204 may subsequently update the CBUIs of respective devices 100, to mark thread 203A as obsolete, or omit the representation of thread 203A altogether.

In another example, a person with a certain role in an organization (e.g. a sales representative), may receive a communication 10 (e.g., a text message) from another member of the organization (e.g., receive an email from his organization's chief financial officer (CFO)), concerning a specific subject (e.g., a business opportunity that may have arrived, and may involve a third-party client). Trigger module 202 may recognize user action 21A (e.g., sending of the communication over OCN 20) as a triggering event, and may produce a trigger 202A.

Communication analysis module 201 may analyze at least one data element included in the communication, and extract one or more communication properties therefrom.

In some embodiments, communication analysis module 201 may extract the at least one communication property data element relating to the communication protocol. For example, communication analysis module 201 may receive different types of communications (e.g., communication email messages, text messages, etc.) and may extract at least one data element relating to the structure of each communication, so as to differentiate between different data elements that may be included in the communication (e.g., a subject line, a message content, etc.) for further analysis. Additionally, or alternately, communication analysis module 201 may receive the communication in a unified OCN protocol from at least one communication module (e.g., 210, 220), as elaborated herein, in relation to FIG. 2.

Communication analysis module 201 may include a natural language processing (NLP) module 201A. In the case that the communication may be or may include at least one text element, NLP 201A may be configured to extract at least one communication property data element pertaining to the text communication, including for example: a communication subject (e.g., “business opportunity”), a communication content or part thereof, a communication context (e.g., relevance to a specific group or business unit), an identity of one or more users that are related to the at least one communication (e.g., the sales representative, the CFO and the client).

Alternately, the communication may be or may include at least one audio data element (e.g., a voice message or a phone discussion). Communication analysis module 201 may include a speech-to-text module 201B, configured to turn the at least one audio data element to a text data element, and propagate the text data element to NLP 201A, which may extract the at least one communication property data element

According to some embodiments, NLP 201A may be configured to extract at least one communication property data element pertaining to membership property of the one or more users related to the at least one communication. Pertaining to the sales representative example, NLP 201A may be adapted to identify, from the content of the communication, organization members that may be stakeholders relating to the communication (e.g., an engineer may be related to a product that the sales representative may sell). Communication analysis module 201 may subsequently assign a membership property to the identified stakeholders and thread manager 203 may add the identification of the relevant stakeholders and respective membership properties to the respective thread.

Thread manager 203 may consequently and automatically create or generate a thread 203A, including, for example thread data elements pertaining to the subject and content of the data message, the identities of members involved in the communication (e.g. the CEO and sales representative) the identification of the relevant stakeholders and respective membership properties.

According to some embodiments, the thread may further include data that may be stored in an organizational database (e.g., data relating to the third-party client, stored on the organizational CRM database 230C of FIG. 2). Pertaining to the sales' representative example, NLP 201A may extract at least one communication property data element, such as a success or failure of the business opportunity, and the organizational database 230C (e.g., the CRM) may be updated according to the extracted communication property.

According to some embodiments, communication analysis module 201 may include an image processing module 201D. In the case that the communication may be or may include at least one image and/or video data element (e.g., asynchronous communication of an image or a video file, synchronous communication of an audiovisual content, such as a video conference call, etc.), image processing module 201D may be configured to extract or obtain at least one communication property data element pertaining to the communicated image and/or video, including for example: an identification of a face of a user that may be included in the communication, an identification of an object that may be included in the communication and the like.

For example, a group of users may participate in a video discussion or conference over OCN 20. Generator 203B of thread manager 203 may create or generate a thread that may include or pertain to the subject of the discussion. Image processing module 201D may be configured to identify at least one face of a person that may be photographed or imaged as part of the discussion, and thread manager 203 may add to the thread the identity (e.g., a name, an email address, etc.) and/or a membership property (e.g., a role in the organization) of the identified person.

Thread manager 203 may assign a value of an extracted communication property 201C of one or more specific communications 10 to a respective thread data element of one or more specific threads 203A, so as to associate between the one or more specific communications 10 and the one or more specific threads 203A. For example, one or more thread data elements may be assigned a value of a communication property 201C, such as a communication subject (e.g., “business opportunity”, in the above example).

Thread manager 203 may include an aggregator module, configured to aggregate one or more communications, or references thereto, into threads 203A, so as to encompass different, but related instances of communication. The aggregator module may assign a value of an extracted communication property 201C of two or more specific communications 10 to a respective thread data element of a specific thread 203A, so as to aggregate or associate between the two or more communications and the specific thread.

Pertaining to the same example, any further communication that may relate to the subject of the thread (e.g. “business opportunity”) and/or to the same identified stakeholders may be consequently aggregated or appended to the same thread 203A.

In some embodiments the two or more communications may be of the same type and/or protocol (e.g., communicated voice messages). Additionally or alternately, the two or more communications may differ in at least one of a communication type and a communication protocol. For example: a first communication may be an asynchronous communication of a text message protocol, and a second communication may be a synchronous communication of a VOIP protocol.

In another example, a first user 100 and a second user 100 may conduct a phone call over OCN 20, using for example VoIP. Communication analysis module 201 may be configured to convert speech data conveyed by VoIP to text and extract at least one communication property therefrom (e.g., the subject and content of the conversation). The at least one communication property data may be stored on thread database 230B, alongside contextual metadata (e.g. the time and duration of the conversation).

Thread manager 203 may be configured to analyze the stored data element and create a respective thread (e.g., relating to the communication's subject and/or content). For example: an email sent among members of a work group may be utilized by thread manager 203 to create a thread having the same subject as the email message. The thread may refer to or may contain the content of the email message. Aggregator 203C may be configured to aggregate or associate additional communications (e.g., data messages and voice calls) relating to a common communication property (e.g., referring to the same subject, or relating to the same users) to the same thread.

CBUI manager 204 may instructor configure CBUIs of relevant devices 100 to present a representation of the one or more specific communications as part of the respective, associated one or more specific threads. In other words, thread 203A, as presented on the CBUI of the respective devices 100 may include a representation or image (e.g., an icon, a pointer, a link and the like) of one or more associated communications (e.g., recorded phone calls, text messages, emails, etc.).

In another use case example, a thread 203A may be dynamically altered according to data stored in the organization's storage system (e.g., database 230C). In relation to the above example, a member of the organization (e.g. the sales representative) may leave the organization, and may have his details omitted or removed from the organizational directory service (e.g., Active Directory server 230C). Embodiments may consequently alter the thread, to comply with the changes in the data (e.g., replace the representative's identity details with those of another representative who has taken over the client's account).

According to some embodiments, CBUI may enable a user (e.g., of user device 100) to perform at least one action that is an administrative thread action based on at least one membership property. For example, a membership property may enable an administrative user to perform (e.g., via admin input 21B) at least one of:
initiating a thread 203A (e.g., in order to include future communications therein);
archiving or deleting a thread (e.g., from thread database 230B);
propagating and/or blocking propagation of a thread over OCN 20 (e.g., from CBUI manager to one or more computing devices 100).

For example, an administrative user in an organization may configure an embodiment of the system to create a thread 203A concerning a specific subject (e.g., a project that is being developed or handled by the organization). Any further communication relating to the project may consequently be automatically aggregated by an embodiment of the system to this thread.

In another example, an administrative user may configure a thread as being redundant, and an embodiment of the system may consequently archive the thread or delete it altogether. Relating to the example above, an administrator may determine that a project has been completed or aborted. According to some embodiments content of the respective thread may therefore be considered redundant, and may be either archived, or purged altogether, according to predefined configurations.

According to some embodiments, an administrative user may configure one or more threads 203A to be associated with a predefined time scope, or context, and may be changed automatically by a processor according to the predefined scope or context.

For example, a thread concerning members of the organization going out for lunch may be configured to be automatically purged by a processor after lunchtime has elapsed.

According to some embodiments the plurality of threads 203A stored in the threads-database 230B may be utilized by the processor 200 to continuously improve the processes of data extraction from communications over the OCN, and consequent creation and maintenance of threads. For example, aggregator 203C may be, or may include at least one machine learning (ML) model 203C-1, trained to group or associate communication properties (e.g., subjects of communicated messages and/or content and context thereof) into groups, where each group may represent a specific thread 203A.

ML module 203C-1 may be configured to apply artificial intelligence or machine learning technology to the communication's content and context to deepen the knowledge of the communication's context (e.g., beyond communication properties such as communication metadata, identification of users in images and NLP metadata). ML module 203C-1 may be configured to identify and map underlying hidden connections and correlations among communications and among communication threads, as known in the art.

For example, image processing module 201D may be configured to identify a face of one or more people in at least one video stream or photo (e.g., of a person photographed in an online video discussion). ML module 203C-1 may be configured to uncover higher order hidden content, context or meaning in the appearance of the identified faces. ML module 203C-1 may subsequently associate the identified faces with respective (e.g., additional) threads (e.g., threads related to the subject of the online discussion).

ML module 203C—may be implemented as any type of appropriate supervised model (e.g., a supervised classification model) and may be trained by receiving one or more administrative input 21B, that may include a label of one or more specific communications as pertaining to a specific thread, as known in the art.

According to some embodiments, one or more of modules 201A, 201B, 201D and 203C-1 may be or may include neural network (NN), e.g. a neural network implementing machine learning as described herein.

According to some embodiments, the data stored in the threads-database 230B may also be utilized by an administrative user for purposes of monitoring data security and auditing of communication and work processes within the organization. For example, the one or more communication properties extracted by NLP 201A (e.g., a phrase that may have been said in a phone conversation including at least one user 100 connected to OCN 20) may be searched and found by an administrator to ascertain whether a security breach has occurred.

Embodiments may provide a benefit over prior art in relation to management and searching of stored thread data elements. For example, the aggregation of data into threads according to one or more communication data elements (e.g., subjects of communications, users participating in communications, context of communications etc.) may enable users (e.g., administrative users of the OCN) to search or browse through specific data according the threads (e.g., browse through threads of specific subjects, search for communications involving specific users etc.). Moreover, the standardization or formatting of communications (e.g., between different ECN communication protocols to OCN proprietary communication protocols, as explained herein) may facilitate searching for specific data elements (e.g., a name or a phrase) that may be included in a plurality of communications, having a respective plurality of format and protocols.

According to some embodiments, OCN manager 200 may reside in a cloud environment. In this configuration, administrative users may have global access to the OCN manager 200, and may provide administrative input 21B to control communication over OCN 20 from virtually anywhere.

Embodiments of the present invention may include a method and a system for dynamically aggregating data relating to different communications concerning a common subject, over an OCN 20 into unified threads (e.g., element 203A), and enabling members of the organization to interact over OCN 20, in relation to the unified threads, according to their respective membership-properties 230A-1 (e.g., their roles in the organization).

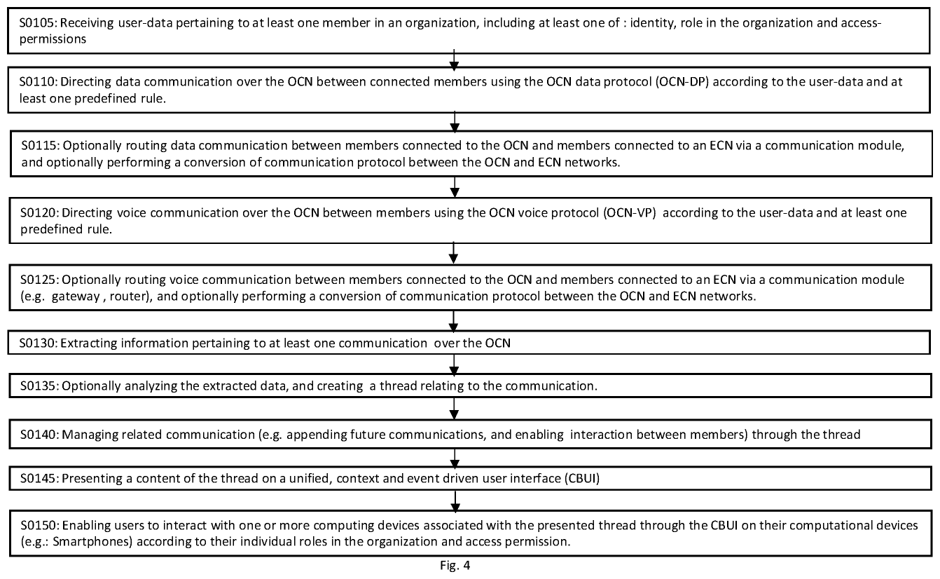

Reference is now made to FIG. 4, which is a flow diagram depicting an example of a method for managing communication over OCN 20 according to some embodiments. While methods disclosed herein, such as the embodiment of FIG. 4, may be used with systems such as shown in FIGS. 1 and 2, other systems and hardware configurations may be used.

As illustrated in step 50105, a system (e.g., system 99) may receive (e.g., from member database 230A) user data pertaining to at least one member in an organization, including for example at least one of: details of the identity of that member, the member's role in the organization, and access-permissions attributed to the member.

As illustrated in step 50110, system 99 may direct data communication over OCN 20 between at least two connected members using an OCN data protocol (OCN-DP), according to user data, through communication devices (e.g. network switches). According to some embodiments, the direction of the communication may further be configured according to at least one predefined rule (e.g. enabling or prohibiting the user to communicate through OCN 20, and access other entities in the OCN 20).

As illustrated in step S0115, system 99 may route communication of data between members connected to OCN 20 and members connected to an ECN (e.g., 40, 50, 60) via a communication module (e.g., router or gateway 220 (e.g., 220A, 220B, 220C, 220D)). According to some embodiments ruting between the OCN 20 and at least one ECN may include performing a conversion of communication protocol between the OCN and ECN network protocols.

As illustrated in step S0120, system 99 may direct voice communication over OCN 20 between members using the OCN voice protocol (OCN-VP), according to the user data (e.g., one or more membership properties) and optionally according to at least one predefined rule (e.g., as dictated by one or more administrative inputs 21B) as elaborated herein.

As illustrated in step S0125, system 99 may route voice communication between users or members using for example user device 100 of FIG. 2, connected to OCN 20 and users or members connected to an ECN (e.g., using user device 400 of FIG. 2) via a communication module (e.g. gateway and/or router 220D). System 99 may optionally include performing a conversion of communication protocol between an OCN 20 communication protocol (e.g., OCN-VP) and the ECN communication protocol (e.g., VOIP), as elaborated herein, in relation to FIG. 2.

As illustrated in step S0130, communication analysis module 201 may extract at least one communication property including information pertaining to at least one communication over OCN 20. The information may include for example: a subject of a communication, a content of the communication, members and entities involved in the communication, etc.

As illustrated in step 50135, thread manager 203 may analyze the extracted information, to generate at least one thread 203A respective of the communication.

As illustrated in step 50140, system 99 may manage related communication through the generated at least one thread 203A. For example, thread manager 203 may append future communication regarding a similar subject to the same thread, thus associating between different communications of related content.

For example, members of an organization (e.g., member M1 and member M2) may discuss a specific subject (e.g., going to lunch) over a first communication (e.g., via an email message), and another group of members (e.g., M2, M3 and M4) may discuss a related subject (e.g., the quality of nearby restaurants) over a second communication (e.g., a cellular text message). Embodiments of the system may be configured to combine or aggregate data from these two different communications into a single thread (e.g., a “food” thread). The thread may be stored (e.g., on thread database 230B) and may include, for example, a subject (e.g., “food”), a content of the communications (e.g., the text of the communication and/or a reference thereto), an identity of the involved users (e.g., M1, M2, M3 and M4), and metadata relating to the communications (e.g., the timing thereof).

As illustrated in step 50145, system 99 may enable interaction between users or members involved in the communication. CBUI manager 204 may configure user devices of one or more users or members involved in the communication to present a content of the thread on a unified, context driven and event driven user interface (CBUI) on at least one member's computing device 100.

According to some embodiments, the CBUI may enable users to interact with one or more computing devices associated with the thread through the CBUI on their computing devices 100 (e.g., Smartphones), according to user data, including for example: the members' individual roles in the organization, members' access permission, etc., as elaborated herein.

According to some embodiments, system 99 may aggregate data relating to different communications over the OCN into threads, where at least one communication may be associated with an ECN, and a respective ECN communication protocol.

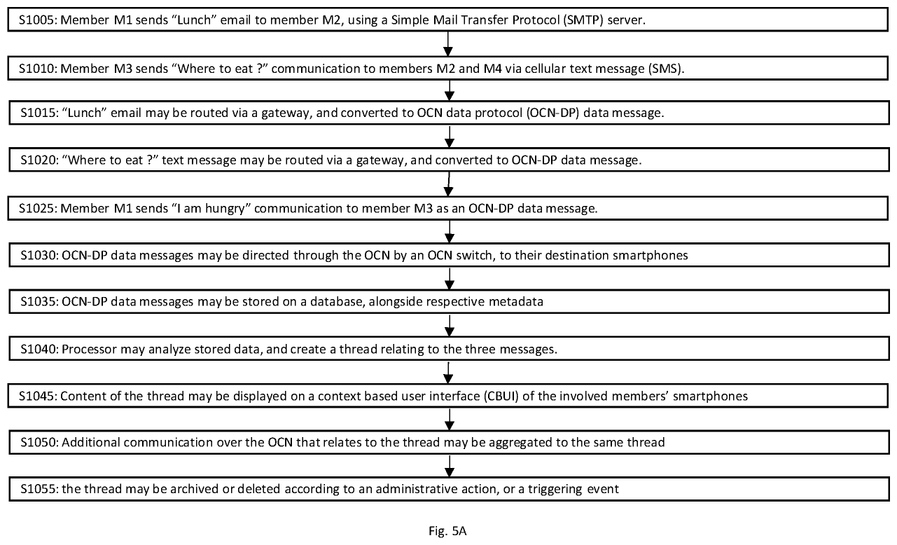

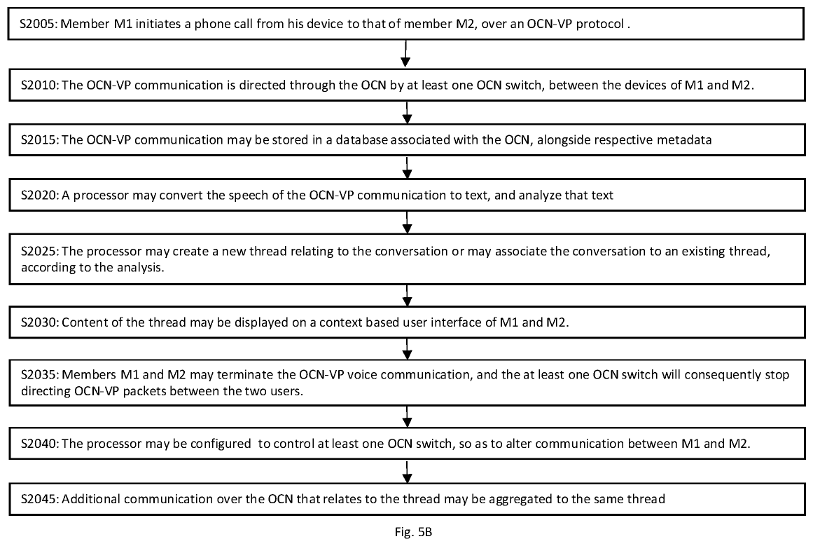

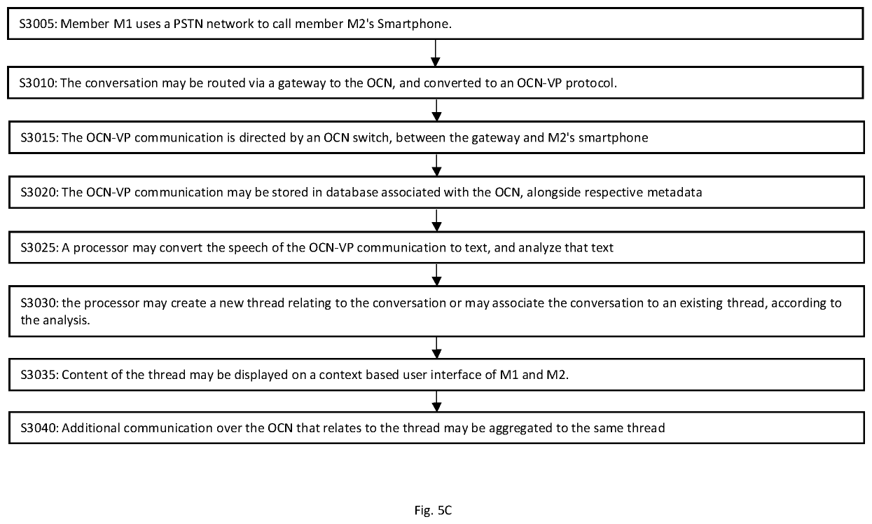

Reference is now made to FIG. 5A, depicting a flow diagram pertaining to an example of a use-case scenario of system 99.

As illustrated in step S1005, a first member (e.g., member M1) may send a data message to a second member (e.g., member M2). For example, M1 may communicate his will to dine over an email, using a Simple Mail Transfer Protocol (SMTP) server (e.g., element 500 of FIG. 2), to member M2's Smartphone.

As illustrated in step S1010, a third member (e.g., member M3) may send data messages of a similar subject (e.g., “where to eat?”) to member M2 and to a fourth member (e.g., M4). For example, M3 may consult M2 and M4 on where to eat by sending them a cellular text message (e.g. a Short Messaging Service (SMS)) from a cellular network (e.g., ECN 40 of FIG. 2).

As illustrated in step S1015, the email message's communication may be routed via a gateway (e.g., 220B) to OCN 20. OCN manager 200 may configure the gateway (e.g., 220B) to convert the email to a uniform or common OCN data protocol (e.g., OCN-DP) message, as elaborated herein.

As illustrated in step S1020, the cellular text message's communication may be routed via a gateway (e.g., 220D) to OCN 20. OCN manager 200 may configure the gateway (e.g., 220D) to convert the message to a uniform or common OCN data protocol (e.g., OCN-DP) message, as elaborated herein.

As illustrated in step S1025, M1 may send an OCN-DP data message over OCN 20, regarding a similar subject. For example, M1 may send an “I am hungry” communication to member M3 as an OCN-DP data message.

As illustrated in step S1030, OCN manager 200 may configure at least one OCN switch 210 to direct the OCN-DP messages through OCN 20, to their destination computing devices 100 (e.g., smartphones). For example, M2 may receive the email message from M1, M4 and M2 receive the SMS message from M3, and M3 receives the OCN-DP message from M1.

As illustrated in step S1035, system 99 may store the three OCN-DP messages in a database (e.g., thread database 230B), alongside or with respective metadata, including for example: the time of each communication, origin and destination of each communication, identities of the members involved (e.g., M1, M2, M3, M4), protocols of the original communications (e.g. SMS and SMTP), etc.

As illustrated in step S1040, OCN manager 200 may analyze the stored data and create a thread, relating to the three messages. The thread may include, for example at least one of: a common subject (e.g., “lunch”), a content of the one or more original communications (e.g. content of the OCN-DP messages or a reference thereto) and the respective metadata.

As illustrated in step S1045, CBUI manager 204 may configure at least one user device 100 of the involved members (e.g., M1, M2, M3, M4) to display content of the thread on a CBUI, as elaborated herein in relation to FIG. 6.

As illustrated in step S1050, OCN manager 200 may aggregate additional communication over OCN 20, that relates to the thread (e.g., of related members discussing lunch) to the same thread (e.g., the ‘lunch’ thread), as long as the thread is active.

As illustrated in step S1055, the thread may be archived or deleted according to an administrative action (e.g., via administrative input 21B) or according to a triggering event (e.g., when lunch time has passed).

According to some embodiments, the system may be configured to direct data files through the OCN via the OCN-DP protocol, where the files are of various file types including, for example: documents, pre-recorded audio files (e.g. voice messages), pre-recorded video files (e.g. audio-visual messages), and the like.

According to some embodiments, the system may be configured to convert speech to text and associate the content of voice communication through the OCN as text files in a thread.

Pertaining to the example discussed above, in relation to FIG. 5A, members of the organization may discuss going to lunch over the phone. The phone voice communication may be directed through the OCN as OCN voice protocol (OCN-VP) communication. Speech to text engine 201B may convert the speech conveyed over the OCN-VP communication to text. NLP 201A may analyze that text, and associate the subject of discussion to the appropriate thread (e.g. the “Lunch” thread).

According to some embodiments, the OCN-VP protocol may be a standard voice protocol (e.g., Voice over IP (VoIP)). Alternatively, the OCN-VP may be a proprietary protocol, suitable for transferring voice communication over the OCN.

System 99 may be configured to enable members to conduct voice communication between two computing devices within OCN 20, over the OCN-VP protocol. Embodiments of the system may also be configured to enable members to transfer live video communication between two computing devices within the OCN over the OCN-VP protocol, including for example for conducting live synchronous video conferencing sessions.

Reference is now made to FIG. 5B, depicting a flow diagram of a phone call, that originates on the OCN and terminates on the OCN.

As illustrated in step S2005, a member (e.g., M1) may initiate a phone call from his device to that of another member (e.g., M2), over a OCN-VP protocol (S2005).

As illustrated in step S2010, the OCN-VP communication may be directed through OCN 20 as OCN-VP packets by at least one OCN switch 210, between the two connected devices 100 (e.g., pertaining to M1 and M2).

As illustrated in step S2015, the OCN-VP communication may be stored in a database associated with OCN 20 (e.g., thread database 230B), alongside respective metadata, including for example: the time of the conversation, origin and destination of the conversation, identities of the members involved (e.g., M1, M2), etc.

As illustrated in step S2020, communication analysis module 201 may convert the speech conveyed over the OCN-VP communication to text and analyze that text to extract at least one communication property 210C.

As illustrated in step S2025, thread manager 203 may consequently create a new thread 203A relating to the conversation, or may associate the conversation to an existing thread 203A. The thread may include, or refer to at least one of: a subject of the conversation, the content of the conversation, and the stored metadata.

As illustrated in step S2030, a content of thread 203A may be displayed on a CBUI of the involved members' computing devices, as explained herein.

As illustrated in step S2035, the involved members (e.g., M1 and M2) may choose to terminate the OCN-VP voice communication through the CBUI, and the at least one OCN switch 210 may consequently stop directing OCN-VP packets between the two user devices 100.

As illustrated in step S2040, OCN manager 200 may be configured to control at least one OCN switch 210, so as to alter communication between the members involved in the voice communication (e.g., M1 and M2). For example, OCN manager 200 may halt communication between the members according to the text analysis. In another example, the processor may receive an instruction from an administrator (e.g., via administrative input 21B) to alter the communication (e.g., end the conversation) between the members, and the processor may consequently configure switch 210 to act accordingly (e.g. disconnect the communication).

As illustrated in step S2045, OCN manager 200 may aggregate additional communication over the OCN that relates to the same thread (e.g., communication among a similar group of members, or related members, discussing a similar subject) to the same thread 203A, as long as the thread is active (S2045), as explained herein.

According to some embodiments, system 99 may aggregate information conveyed on a voice communication between at least two users in a thread, where at least one of the users is communicating via an external telephony network ECN (e.g. cellular network 40 or Public Switched Telephone Network (PSTN) 60). Reference is now made to FIG. 5C, which is a flow diagram, depicting an example for such a use-case scenario.

As illustrated in steps S3005 and S3010, a first member (e.g., M1) may use an external voice communication network (e.g. PSTN ECN 60) to call second (e.g., M2) member's Smartphone. The conversation may be routed via at least one first communication device (e.g. a gateway, a router) 220A to OCN 20, and converted to an OCN-VP protocol as explained herein.

As illustrated in step S3015, the OCN-VP communication may be directed through the OCN by at least one second communication device (e.g. OCN switch 210), between gateway 220A and M2's smartphone device 100.

As illustrated in step S3020, system 99 may store data pertaining to the OCN-VP communication in at least one database associated in thread database 230B, alongside respective metadata, including for example: the time of the conversation, origin and destination of the conversation, identities of the members involved (e.g., M1, M2), etc.

As illustrated in step S3025, communication analysis module 201 may convert the speech conveyed over the OCN-VP communication to text and analyze the text to extract at least one communication property 201C, as elaborated herein.

As illustrated in step S3030, tread manager module 203 may create a new thread 203A relating to the conversation based on the text analysis. Additionally, or alternately, thread manager module 203 may associate the conversation with an existing thread 203A based on the text analysis, as elaborated herein. Thread 203A may include or refer to at least one of: a subject of the conversation, content of the conversation, and metadata association with the conversation.

As illustrated in step S3035, data related to the content of the thread may be displayed on a CBUI of one or more involved members and may be accessible to the involved members on their computing devices, as explained herein.

As illustrated in step S3040, tread manager module 203 may aggregate or combine additional communication over the OCN that relates to the thread (e.g., of related members discussing lunch) to the same thread (e.g., a ‘lunch’ thread, as elaborated in the previous example), as long as the tread is active. The additional communication may also be accessible to the involved members on their computing devices as elaborated herein.

According to some embodiments, an embodiment of the system may be configured to present data relating to threads in a CBUI, on the display of a computing device of members of the organization. The user interface may be unified in a sense that it may present, to one or more involved users or members, data pertaining to communications of different types and/or protocols in a single, generalized format.

Reference is now made to FIG. 6, depicting an example of a CBUI, according to some embodiments.

According to some embodiments, CBUI 101 may be configured to be context and member-identity driven. Characteristics of CBUI 101 may be uniquely defined by CBUI definitions that may be specific for each member of the organization, and may be based on for example: the member's location, identify and role in the organization. For example, a first user having a first membership property (e.g., a role in the organization) may be enabled to view a first subset of communications pertaining to a specific thread, and a second user, having a second membership property, may be enabled to view a second subset of communications pertaining to the same thread.

According to some embodiments, CBUI definitions may be pushed or transmitted to the member computing device 100 (e.g. Smartphone) upon the member's connection to OCN 20. For example, when a user arrives at a hotel, their phone may connect to the hotel's OCN, and he may consequently be attributed a membership as a ‘guest’ user. The guest's smartphone may consequently be enabled with communication schemes and privileges that the hotel grants his guests. For example, the guest's CBUI 101 may present direct access keys associated with function holders at the hotel that the guest should have access to, including the front desk, the concierge, the bellboy, the gym, the restaurant, etc. The guest's CBUI 101 may provide access to communication over the OCN with other guest members of his party that share the same hotel reservations record (e.g., other family members or colleagues traveling with him). In contrast, employees of the hotel who may also be connected to the OCN may have other properties and capabilities displayed on their CBUI 101. For example, a housekeeping manager of that same hotel may be assigned communication schemes and privileges that are related to his role and responsibilities at the hotel. This may include, for example, direct access keys with pre-configured access numbers, to establish communication with various role players, including the hotel's manager, logistics and operations of the hotel housekeeping function.

According to some embodiments, one or more CBUI definitions or properties (e.g., appearance, capabilities, etc.) may be specific to each organization, and may be predefined for each member according to their identity, and their attributed roles and permissions within the organization.

According to some embodiments at least one definition or property may be modifiable by the member, to enrich and/or modify the pre-defined CBUI properties. For example, a CBUI 101 of a workplace may be configured to present the workplace's logo, and a member may be enabled to select additional features to be displayed (e.g., a background image).

According to some embodiments, based on context and the member's identity, CBUI 101 may present or display pre-defined communication groups and quick access keys to other entities (e.g., a contacts list, a contact group, etc.) that may relevant to that specific member and to their role in the organization.

CBUI 101 may present or display a unified view of one or more threads, where each thread may be presented on a different page, line or tab, facilitating both an overview of all threads and a focused, interactive view of selected threads.

CBUI 101 may enable members of the organization to dynamically interact with other members, and access data stored on organizational storage systems through OCN 20, according to individual members' membership properties (e.g., organizational roles and predefined permissions). The interaction of a first user with other members may be dynamic, for example in a sense that the first user may perform at least one action, as elaborated herein (e.g., initiate a phone call with a second user) following a change in the representation of the thread on their CBUI. This change may in turn be dynamic in a sense that it may follow, or be subsequent to occurrence of a triggering event (e.g., when the second user has connected to the OCN, or when the second user has sent a message to a third user).

FIG. 6 presents an exemplary, non-limiting, schematic view of CBUI 101, when presenting an overview of all active treads concerning a specific user, according to some embodiments. CBUI 101 may be presented or displayed for example on a screen of a computing device 100 such as a user's smartphone, laptop or desktop computer.

The presented overview may include several hierarchic categories, from which the user may be prompted to choose or select.

A first hierarchic category may include a category of OCNs 110 of which the user may be a member of (e.g., OCN1, OCN2, OCN3, etc.). For example, a traveler who is on a business trip may stay at a specific hotel and spend some leisure time in a gallery. The different selectable OCNs may consequently be or represent the user's workplace's OCN (e.g., OCN1), the hotel's OCN (e.g., OCN2), and the gallery's OCN (e.g., OCN3). The traveler may choose one of the above OCNs, to interact with respective treads. According to the exemplary embodiment depicted in FIG. 6, this selection may be done in selection box 110, for example, by tapping the icon/name of the selected OCN, by scrolling the OCN list or by swiping motion of the device screen to a specific direction. It should be appreciated by those skilled in the art that other selection methods may be used as may be known in the art.

In some embodiments, the plurality of OCNs (e.g., OCN1, OCN2, OCN3, etc.) may be associated with a respective plurality of CBUIs 101. For example, when a user selects a specific OCN (e.g., OCN1), on their computing device, CBUI 101 may be changed to present data associated with the selected OCN. For each selection of an OCN, CBUI 101 may be configured to present the relevant one or more tread data elements according to a context of respective triggering events. The presentation of CBUI 101 may be personalized according to the membership property of the at least one user in relation to the respective OCN. For example, each CBUI may present data that the user may be allowed to access, according to their permissions in each of the respective OCNs.

A second hierarchic category may be an OCN sub-hierarchy. Pertaining to the same example, the traveler may be prompted to select a sub-hierarchical group of one OCN. For example, the user may choose one sub-hierarchical group (e.g., group 1) of his workplace (e.g., the engineering division, software division, finance division or the human resources (HR) division), in order to interact with threads pertaining to the selected sub-hierarchy. According to the exemplary embodiment depicted in FIG. 6, this selection may be done in selection box 120.

A second hierarchic category may be a tread that concerns the member. For example, a user who is a member of the software division may choose to view a thread that relates to a subject of a known software issue, and thus be able to access data pertaining to any type of communication that has been transferred between members of the software division over OCN 20, in relation to that subject.

According to the exemplary embodiment depicted in FIG. 6, each tread may be associated with one of a plurality of tread key boxes 160. A user may select a thread by tapping a specific thread key box 160, and CBUI 101 may consequently present a thread-specific view, as explained herein.

According to some embodiments, one or more key boxes 160 may be pre-configured to allow quick access and/or direct communication with certain other members or group of members of the organization. For example, on a CBUI 101 of a software development manager, one key box 160 may be configured to initiate a direct voice call with their assistant, another may be configured to initiate a direct voice call with their VP of R&D and a third key box 160 may be configured to open a direct messaging session with their entire software development team.

According to some embodiments, text box 130 may be configured to notify a user of an occurrence of an event related to a tread, including for example: creation of a new tread, deletion of a thread, reception of a new message relating to a tread, incoming call relating to a specific thread, etc. According to some embodiments, tread boxes 160 may be configured to change appearance (e.g., blink, change color, etc.) in concurrence with the notification on text box 130, to help the user associate the notified event with a specific thread or communicating party.

According to some embodiments, text box 140 may be configured to present additional information to the user regarding thread-related events, including for example: a content of a text message associated with a specific thread, an identified number of an incoming call, etc.

According to some embodiments, action boxes 150 may be configured to enable a user to act on a specific thread. For example: the user may choose to send a text message, send an email, initiate a phone call or initiate a conference call with one or more members of the organization associated with a specific thread.

According to some embodiments, CBUI configuration boxes 170 may be context dependent, and may enable a user to apply actions in the context of a state of CBUI 101.

For example, if a user chooses to initiate a conference call in relation to a specific thread, by using action boxes 150, then configuration boxes 170 may be configured to enable the user to activate a camera of the computing device 10, mute/unmute a microphone of the device 10, transfer to another call, etc.

In another example, if a user chooses to send a text message communication in relation to a specific thread, by using action boxes 150, then configuration boxes 170 may be configured to enable the user to: choose a protocol or application of a destination user's computing device (e.g., a third-party protocol such as WhatsApp, Skype, an email protocol such as SMTP, Cellular SMS protocol, etc.), choose to add additional members to the thread in order to copy them on respective text messages, etc.

According to some embodiments, the CBUI search icon 180 may enable the user to search for elements relating to specific OCNs, OCN sub-hierarchies and/or threads. The searchable elements may include, for example: identities of members of the organization, historical data and voice communications conducted over the OCN, etc.

According to some embodiments, CBUI 101 may include an additional view or display presenting a focused interactive view of a selected thread. For the purpose of brevity, this view may be herein referred to as the ‘thread’ view. The thread view may enable a user to perform one or more thread-specific actions.

For example, the thread view may facilitate interaction of one or more members of the organization related to the thread through OCN 20, by sending and receiving messages over the OCN, using an OCN communication protocol (e.g., sending a text or data message via the OCN-DP protocol, initiating a conference call via the OCN-VP protocol, and the like).

In another example, the thread view may facilitate interaction with one or more user connected to an ECN by sending and receiving messages to that user via a gateway between the OCN and the ECN. For example: a member of the organization may communicate with a user (e.g., 400) of a cellular network's ECN 40 texting service via a gateway (e.g., 220D), as explained herein.

In another example, the thread view may allow conducting voice calls between members of the organization over the OCN, using a suitable communication protocol, such as the Voice over Internet Protocol (VoIP).

In another example, the thread view may allow conducting voice calls between members 100 of the organization connected to OCN 20 and one or more users (e.g., 600) of external telephony networks, such as PSTN 60 via a gateway (e.g., 220A), as explained herein.

Other or additional capabilities supported by the thread view may include, for example:
communicating between any two computing devices through the OCN by Open Systems Interconnection (OSI) protocols, including for example Transmission Control Protocol/Internet Protocol (TCP/IP), User Datagram Protocol (UDP) and Hypertext Transfer Protocol (HITP);
communicating between any first computing device within OCN 20 and a second device connected to an ECN via a router (e.g., CBUI 101 may facilitate browsing the internet by connecting to the internet via a router, as explained herein);
enabling a user to access data stored within the OCN (e.g., on organizational database 230C) according to access-permissions attributed to that user, and
conducting a thread-specific search (e.g., on the content of thread database 230B) according to any type of data or metadata aggregated within a thread, including for example: data relating to communications aggregated in the thread (e.g., subject, content, context, communication protocol, etc.), identity and roles of members of the organization related to the thread, and metadata related to the thread (e.g., size and timing of events and communications over the OCN, priority and schedules related to the thread, causality of treads, etc.).

According to some embodiments, CBUI 101 may display the thread view on a user's computing device according to a triggering event from a predefined list of triggering events.

For example, the thread view may pop up or appear on the display, or be moved upwards in a priority list following occurrence of a triggering event such as connection of the user's computing device to an OCN, a contextual changes (e.g., the user's birthday date has arrived).

In another example, the thread view may be changed following a triggering event that may include a correlation between the thread of interest and another thread. Pertaining to the software issue thread example discussed herein, if the same software issue is also discussed over communications relating to another thread, thread manager 203 may associate or unite the two threads, and CBUI 101 may present or mark the two treads as united or correlated.

In another example, a triggering event may be a change relating to the user on an organizational database 230C. For example, a change in the roles and permissions attributed to the user within the organizational active directory (e.g., when a user leaves the organization) may affect the user's relation to threads within the organization, and will be included in the CBUI 101 display (e.g., a user who has left the organization may be omitted from respective threads).

In another example, a triggering event may be a change made to a thread, to which the user is associated. For example, an administrator may assign a high priority to a specific thread, and CBUI 101 may consequently present that thread as important.

In some embodiments, triggering events may include one or more communication actions.

For example, an incoming or outgoing communication on the OCN, to which the user is associated. For example, if another member of the organization that is related to a specific thread calls the user's computing device over the OCN via VOIP, CBUI 101 may pop up the thread view relating to the thread of interest, to allow the user to access relevant thread data while conducting the phone call.

In another example, an incoming communication from an ECN, to which the user is associated, may be received. For example, an employee of an organization may use a cellular text messaging service to notify his boss that he will not be able to come to work that day. This message may be routed via a gateway through the OCN and be displayed on the boss's Smartphone. CBUI 101 may consequently pop up a thread view that concerns a planned meeting, in which the employee is a role player.

According to some embodiments, CBUI 101 may include a ‘group’ view, configured to present, per a selected list of group participants, a view of one or more threads of communication associated with that group of participants. The group view may be configured to enable members to navigate and view data relating to all or part of the threads associated with messages exchanged within the group of participants. According to some embodiments, the group view may further be configured to enable a user to select a specific thread, and consequently open a respective thread view.

According to some embodiments, CBUI 101 may further include a ‘colleague’ view, configured to present one or more treads that may be associated with communication of a specific member with another, specific colleague member.

According to some embodiments, CBUI 101 may include a ‘group manager’ view, to facilitate management capabilities in relation to specific member groups and treads, for members of the organization who are attributed adequate permissions.

The group manager view may enable members to create new threads, delete obsolete threads, add new members to an existing thread and remove members from a dread, so as to prevent them from receiving future thread triggers or communication.

The group manager view may enable members to share with other members of the organization any of a dread's on-going or past communication, on a one-time and need-to-know basis only (e.g. by carbon-copying (CC) a member to a single OCN communication or to the entire thread), without including these members in the thread's participants list.

According to some embodiments, CBUI 101 may include an ‘administrative’ view, to facilitate administrative capabilities for members of the organization who are attributed adequate permissions.

According to some embodiments, the administrative view may be configured to facilitate similar capabilities to those of the group manager view, as elaborated herein, in addition to some administrative capabilities.

For example, the administrative view may enable definition, creation and management of various communication groups.

In another example, the administrative view may enable definition, creation and management of properties of CBUI 101 on at least one of an organizational level, a group level, and a member-specific level.

In another example, the administrative view may enable applying cyber security and data protection management policies on an organizational level, on a group level, and per each member of the organization, according to their role in the organization (e.g. CFO vs. a junior accountant).

In another example, the administrative view may enable definition, deployment and management of properties and policies (e.g. CRM connectivity, recording of voice communications, membership expiration time/triggers, thread expiration events), on at least one of a system level, a group level and an individual level.

In another example, the administrative view may enable addition and deletion of members from the organizational directory service (e.g., Active Directory).

In another example, the administrative view may enable management of databases and directories on the OCN (e.g., 230A, 230B), including for example extraction of statistic information, and performing auditing on hardware and software elements associated with the OCN.

In another example, the administrative view may enable thread-related actions, including at least one of:
creation of new threads;
archiving or deleting redundant dreads;
edition of specific thread parameters (e.g. changing a subject of a thread); and
performance of organization-scale searches throughout a plurality of archived threads (e.g. for the purpose of maintaining data security and conducting audits).

According to some embodiments, the administrative view may enable administrators to define and deploy specific communication schemes, according to specific communication content and associated metadata. Administrators may apply these schemes to control routing of voice and data communication over the OCN.

According to some embodiments, communication schemes may enable or disable communication among members within the organization, according to specific thread subjects and according to the roles and permissions of the members of the organization. For example: an administrator may choose to route all or some of data messages that are associated with a specific third-party format of communication (e.g. ‘WhatsApp’ application) and that relate to a Human Resources (HR) issues to a computing device (e.g. a smartphone or laptop) of a specific person at the HR department.

In another example, an administrator may choose to route incoming data messages (e.g., ‘Skype’ messages) relating to a specific subject (e.g. a technical subject) to a specific member (e.g., a member of a specific technical support team), according to additional organizational information, including, for example: load balancing, context, geographic location and the time of day.

The present invention provides a system and a method for managing communication over an organizational network. The present invention includes a benefit over prior art in a plurality of aspects.

For example, communication over the OCN is or governed centrally, by controlling the transfer of data among nodes of the organizational network according to the context of each communication.

In another example, communications are dynamically gathered or aggregated into context based threads, allowing users or members of the organization to interact with stored data or among themselves according in relation to specific context and according to their membership properties.

In another example, each user's capabilities may be presented and technically facilitated on the fly (e.g., by allowing or disallowing the formation and routing of communication) according to their relationship with specific threads and/or their roles and permissions within the organization, and

In another example, elements of communication of data (e.g., communication types and/or protocols) may be unified into standardized, thread format. This may facilitate combining or aggregating of different data (e.g., different communications) together according to specific thread data elements (e.g., according to subjects of discussion). This aggregation may further enable storing the communicated data in a searchable, manageable format.

Embodiments may provide a benefit over prior art in relation to management and searching of stored thread data elements. For example, the aggregation of data into threads according to one or more communication data elements (e.g., subjects of communications, users participating in communications, context of communications etc.) may enable users (e.g., administrative users of the OCN) to search or browse through specific data according the threads (e.g., browse through threads of specific subjects, search for communications involving specific users etc.). Moreover, the standardization or formatting of communications (e.g., between different ECN communication protocols to OCN proprietary communication protocols, as explained herein) may facilitate searching for specific data elements (e.g., a name or a phrase) that may be included in a plurality of communications, having a respective plurality of format and protocols.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention. Further, features or elements of different embodiments may be used with or combined with other embodiments.

1. A method of managing communication of at least one user of at least one respective first computing device over an organizational communication network (OCN), the method comprising:
receiving an indication of occurrence of a triggering event related to the at least one user, wherein the indication comprises at least one trigger property;
generating a thread, comprising at least one thread data element based on the at least one trigger property;
attributing a membership property to the at least one user;
presenting the at least one thread data element on a context-based user interface (CBUI) of the at least one first computing device according to at least one of the membership property and the trigger property; and
enabling the at least one user to perform at least one action over the OCN, in the context of the thread representation on the CBUI, based on the at least one thread data element and the membership property.

2. The method of claim 1, wherein the membership property is selected from a list consisting of: an identification of the at least one user, the user's role in an organization, pertinence of the user to a specific group in the organization, one or more permissions attributed to the user and one or more data elements relating to a computing device associated with the user.

3. The method of claim 1 wherein the trigger property is selected from a list consisting of: a connection of a computing device to the OCN, disconnection of a computing device from the OCN, an action taken by at least one user on the OCN, changes made to entries or values of an organizational database, a scope of a triggering event and a priority of a triggering event.

4. The method of claim 1 wherein the at least one thread data element is a representation of a data element stored on a computing device on the OCN, and wherein the action is selected from a list consisting of: viewing the stored data element, retrieving the stored data element, modifying the stored data element and deleting the stored data element, and wherein enabling the user to perform the action is based on at least one membership property.

5. The method of claim 1, wherein the at least one thread data element is a representation of at least one second computing device on the OCN, and wherein the at least one action is a communication action between the first computing device and the at least one second computing device.

6. The method of claim 5, further comprising presenting the thread on the CBUI of the first computing device and on the CBUI of the at least one second computing device.

7. The method of claim 5, wherein the communication action is selected from a list consisting of: sending a synchronous communication, receiving a synchronous communication, sending an asynchronous communication, receiving an asynchronous communication, propagating a communication via nodes of the OCN and blocking a propagation of a communication via nodes of the OCN, and wherein enabling the user to perform the communication action is based on at least one membership property.

8. The method of claim 1, further comprising: analyzing one or more communications over the OCN, to extract one or more communication properties selected from a list consisting of: a communication protocol, a communication subject, a communication content, a communication context, an identity of one or more users that are related to the at least one communication and a membership property of the one or more users related to the at least one communication.

9. The method of claim 8, further comprising assigning a value of an extracted communication property of one or more communications to a respective thread data element of a specific thread, so as to associate between the one or more communications and the specific thread.

10. The method of claim 8, further comprising assigning a value of an extracted communication property of two or more communications to a respective thread data element of a specific thread, so as to associate between the two or more communications and the specific thread, wherein the two or more communications differ in at least one of a communication type and a communication protocol.

11. The method of claim 10, further comprising presenting a representation of the two or more communications as part of the associated specific thread on the CBUI.

12. The method of claim 7, wherein propagating a communication via nodes of the OCN is done via an OCN unified communication protocol, and wherein the OCN interfaces with one or more external communication networks (ECNs) using an ECN communication protocol.

13. The method of claim 12, wherein the one or more ECN is selected from a group consisting of: a Wide Area Network (WAN), a metropolitan area network (MAN), an Enterprise Private Network (EPN), a Virtual Private network (VPN), a Local Area Network (LAN), a cellular network, a Public Switched Telephone Network (PSTN), a satellite communication network, an Internet of Things (IoT) network, a machine to machine (M2M) network, and a third-party communication network.

14. (canceled)

15. The method of claim 12, comprising:
receiving at least one communication from a computing device of an ECN, in an ECN communication protocol;
converting the ECN communication protocol of the received ECN communication to a unified OCN protocol; and
propagating the communication via nodes of the OCN in the unified OCN protocol.

16. The method of claim 12, comprising:
receiving at least one communication from a computing device of the OCN, in a unified OCN communication protocol;
converting the unified OCN communication protocol of the received OCN communication to an ECN protocol; and
propagating the communication to a computing device of the ECN.

17. The method of claim 1, wherein at least one thread is stored in a thread database, accessible via the OCN by the one or more users that are related to the at least one thread.

18. The method of claim 16, wherein performing an action over the OCN comprises:
enabling a user to select at least one thread and one or more respective actions via the CBUI;
instructing at least one node of the OCN to perform the action according to the user's selection; and
updating the thread database according to the at least one performed action.

19. The method of claim 17, further comprising updating the thread representation on the CBUI of one or more users related to the thread.

20. The method of claim 1, wherein the at least one action is an administrative thread action, selected from a list consisting of: initiating a thread, archiving a thread, deleting a thread and propagating a thread to one or more computing devices on the OCN, and wherein enabling the user to perform the administrative thread action is based on at least one membership property.

21. A method of managing communication of at least one user of a respective at least one first computing device over at least one organizational communication network (OCN), the method comprising:
receiving an indication of occurrence of a triggering event related to the at least one user;
receiving a membership property of the at least one user; and
presenting a context-based user interface (CBUI) on the at least one first computing device according to the triggering event,
wherein the presentation of the CBUI is personalized according to the membership property.

22. (canceled)

23. The method of claim 21 further comprising:
generating a thread, comprising at least one thread data element based on the triggering event;
presenting the thread on the CBUI according to the membership property; and
enabling the at least one user to perform at least one action over the at least one OCN, in the context of the thread representation on the UI, based on the at least one thread data element and the membership property.

24. The method of claim 21, wherein the at least one thread data element is selected from a list consisting of: one or more communication properties of at least one communication over the OCN, one or more representations of a data element stored on a computing device on the at least one OCN and one or more triggering properties of the triggering event.

25. The method of claim 21, wherein the one or more communication properties are selected from a list consisting of: a subject of a communication, a content of a communication, a reference to a content of a communication, a context of the communication, one or more parameters relating to an identity of at least one user related to the communication, and one or more parameters relating to an identity of at least one computing device related to the communication.

26. The method of claim 21, wherein the at least one OCN comprises a plurality of OCNs, and wherein the method further comprises presenting a respective plurality of CBUIs on the at least one first computing device, according to a context of the triggering event, wherein each presentation of a CBUI is personalized according to the membership property of the at least one user in relation to the respective OCN.

27. A system for managing communication of at least one user of at least one respective first computing device over an OCN, the system comprising: a non-transitory memory device, wherein modules of instruction code are stored, and a processor associated with the memory device, and configured to execute the modules of instruction code, whereupon execution of said modules of instruction code, the processor is further configured to perform at least one of:
receive an indication of occurrence of a triggering event related to the at least one user, wherein the indication comprises at least one trigger property;
generate a thread, comprising at least one thread data element based on the at least one trigger property;
attribute a membership property to the at least one user;
present the at least one thread data element on a CBUI of the at least one first computing device according to at least one of the membership property and the trigger property; and
enable the at least one user to perform at least one action over the OCN, in the context of the thread representation on the CBUI based on the at least one thread data element and the membership property.
